(19) United States
(12) Patent Application Publication
(10) Pub. No.: US 2015/0178685 A1
(43) Pub. Date: Jun. 25, 2015

(54) METHOD AND APPARATUS FOR SELECTING BENEFIT PLANS

(71) Applicant: Assurant, Inc., New York, NY (US)

(72) Inventors: Andrew K. Krumel, Park City, UT (US); Jonathan Robins, Olathe, KS (US)

(73) Assignee: Assurant, Inc., New York, NY (US)

(21) Appl. No.: 14/256,195

(22) Filed: Apr. 18, 2014

Related U.S. Application Data
(63) Continuation of application No. 14/140,436, filed on Dec. 24, 2013.

(51) Int. Cl. G06Q 10/10

(52) U.S. Cl. CPC G06Q 10/1057

(57) ABSTRACT

A method, apparatus, system, and computer program product are disclosed to facilitate the selection of benefits plans. The method may include receiving user profile data. The user profile data may include information defining one or more user characteristics. The method may also include generating a user benefits profile using the user characteristics. The user benefits profile may include one or more properties indicating the appropriateness of at least one feature of at least one benefit plan for the user. The method may also include using the benefits profile to determine, using a processor, one or more benefits selections from a set of benefits offerings including a plurality of benefits plans. The benefits selections may include an instruction to enroll in at least one benefit plan of the plurality of benefits plans. The method may also include providing the one or more benefits selections for confirmation.

### CROSS-REFERENCE TO RELATED APPLICATIONS

This application is a continuation of U.S. application Ser. No. 14/140,436, filed Dec. 24, 2013, the entire contents of which are incorporated herein by reference.

### TECHNOLOGICAL FIELD

Example embodiments of the present invention relate generally to systems that provide for benefit plan selections and, more particularly, to systems and related embodiments configured to analyze and evaluate benefit plan selections based on a particular benefit profile or profiles.

### BACKGROUND

Applicant has discovered problems with current methods for selecting benefit plans. Through applied effort, ingenuity, and innovation, Applicant has solved many of these identified problems by developing a solution that is embodied by the present invention, which is described in detail below.

### BRIEF SUMMARY

Accordingly, methods, apparatuses, and computer program products are provided for selecting benefit plans. Example embodiments may include a method for selecting benefit plans. An embodiment of an example method may include receiving user profile data. The user profile data may include information defining one or more user characteristics. The method may also include generating a user benefits profile using the user characteristics. The user benefits profile may include one or more properties indicating the appropriateness of at least one feature of at least one benefit plan for the user. The method may further include using the benefits profile to determine, using a processor, one or more benefits selections from a set of benefits offerings comprising a plurality of benefits plans. The method may also include providing the one or more benefits selections for confirmation.

In some embodiments, the method may also include, in response to receiving confirmation of the benefits selections, enrolling the user in the at least one benefit plan corresponding to the one or more benefits selections. The at least one benefit plan may include at least one of a medical insurance plan, a life insurance plan, a dental insurance plan, a vision insurance plan, a disability insurance plan, a health savings account contribution, a legal services insurance plan, a retirement contribution, or a catastrophic illness insurance plan. The one or more properties may include a user marital status, whether the user has children, whether the user has a mortgage, the user's age, whether the user is a smoker, whether the user wears corrective lenses, a preexisting medical condition, or a user financial status. The user profile data may be received as responses to a questionnaire, and the method may include providing the questionnaire to the user. The questionnaire may be generated by determining a set of questions associated with the set of benefits offerings, and adding the set of questions to the questionnaire. The questionnaire may also be generated by determining at least one question not associated with the set of benefits offerings, and removing the at least one question from the questionnaire.

In yet further embodiments, the method may include generating a narrative description of the benefits profile, and generating a display comprising the narrative description and the benefits selections. The method may also include determining an essential set of benefits features based on the user profile, and allocating a user benefits allocation to a set of benefits plans satisfying the essential set of benefits features prior to allocating the user benefits allocation to one or more benefits plans that do not satisfy any of the essential set of benefits features. In yet further embodiments, the method includes determining an expected benefits usage based on the benefits profile, determining a cost for one or more of the set of benefits offerings using the expected benefits usage, rating the one or more of the set of benefits offerings based on the cost, and choosing at least one of the benefits selections based on the rating.

The expected benefits usage may include at least one expected medication. In some embodiments, the method also includes determining a classification of the at least one expected medication, determining an expected price based on the classification, and using the price to determine the cost for the one or more of the set of benefits offerings. The method may include determining the cost by performing a trial adjudication of an insurance claim comprising the expected medication. Each of the set of benefits offerings may include one or more benefits parameters, and the benefits parameters may define one or more cost functions for different service types offered by each of the benefits offering. Various embodiments may also include apparatuses and/or computer program products configured to perform the enumerated example methods and similar functionality related to selection of benefits.

Further embodiments may include a method for generating a benefits narrative. The method may include receiving a user benefits profile. The user benefits profile may include one or more properties indicating the appropriateness of at least one feature of at least one benefit plan for a user. The method may also include generating, using a processor, a benefits narrative from the user benefits profile. The benefits narrative may include a natural language summary of the one or more properties as they define the user's circumstances in relation to the selection of one or more benefits plans. The method may also include displaying the benefits narrative, and displaying a benefits selection interface. The benefits narrative may be displayed concurrently with the benefits selection interface. In some embodiments, the benefits narrative is displayed after generating the benefits profile but prior to displaying the benefits selection interface, and the method further includes presenting the benefits narrative to confirm information contained within the benefits profile.

Embodiments may also include comparing a set of benefits selections displayed in the benefits selection interface with the user benefits profile, identifying at least one discrepancy between a first portion of the set of benefits selections and at least a first property of the user benefits profile, determining a first portion of the benefits narrative associated with the first property, and applying a visual effect to the first portion of the benefits narrative associated with the second property. The same visual effect may be applied to the first portion of the benefits selections associated with the discrepancy. The visual effect may include a dialogue box displayed in response to a mouse cursor being placed over the first portion of the benefits narrative. The method may also include receiving a response to at least one question from a questionnaire comprising a plurality of questions used to generate the benefits profile, and the benefits narrative may be incrementally displayed in response to receiving answers to the questionnaire. In some embodiments, the method also includes determining a second discrepancy between a second portion of the set of benefits selections and a second property of the user benefits profile, determining a second portion of the benefits narrative associated with the second property, and applying a second visual effect to the second portion of the benefits narrative associated with the second property and a second portion of the benefits selections associated with the second discrepancy. The method may also include receiving a user input selecting at least a portion of the benefits narrative, and in response to the user input, providing an interface for altering a portion of the user benefits profile associated with the selected portion of the benefits narrative. Various embodiments may also include apparatuses and computer program products for performing the benefits narrative generation functionality as described above.

Yet further embodiments may include a method for generating a benefits profile using a benefits profile template. The method may include receiving one or more answers to a set of template processing questions. The answers may define one or more user characteristics. The method may also include selecting a template group comprising a plurality of benefits profile templates based on the one or more defined user characteristics, and generating, using a processor, a benefits profile for each of the plurality of benefits profile templates. The benefits profile may include the one or more user characteristics and one or more default characteristics associated with the benefits profile template. The method may also include generating a benefits narrative for each of the generated benefits profiles, presenting the generated benefits narratives for selection, receiving a selection of at least one of the generated benefits narratives, and generating a benefits profile based at least in part on the selected generated benefits narrative. In some embodiments, the method may also include determining one or more additional questions based at least in part on the selected benefits profile template, and receiving one or more responses to the one or more additional questions, wherein the benefits profile is generated based at least in part on the one or more responses and the selected generated benefits narrative. Embodiments may also include apparatuses and computer program products for utilizing benefits profile templates as described above.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates an example system within which embodiments of the present invention may operate;

FIG. 2 illustrates a block diagram showing an example device for use in a benefits selection system, in accordance with some example embodiments of the present invention;

FIG. 3 illustrates a block diagram of an example of a data flow for a benefits selection system in accordance with example embodiments of the present invention;

FIG. 4 illustrates a flow diagram of an example method for generating a benefits profile in accordance with example embodiments of the present invention;

FIG. 5 illustrates a flow diagram of an example method for selecting benefits using a benefits profile in accordance with example embodiments of the present invention;

FIG. 6 illustrates a flow diagram of an example method for rating benefits plan offerings in accordance with example embodiments of the present invention;

FIG. 7 illustrates a flow diagram of an example method for determining pharmaceutical costs as a component of a benefits plan selection operation in accordance with example embodiments of the present invention;

FIG. 8 illustrates a flow diagram of an example method for using a benefits narrative to assist with a benefits selection process in accordance with example embodiments of the present invention;

FIG. 9 illustrates an example interface for using templates in conjunction with a benefits profile in accordance with example embodiments of the present invention;

FIG. 10 illustrates an example method for using templates to generate a benefits profile in accordance with example embodiments of the present invention; and

FIGS. 11-15 illustrate example interfaces for interacting with a benefits selection system in accordance with example embodiments of the present invention.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### OVERVIEW AND DEFINITIONS

In an effort to provide competitive compensation packages to employees, it is more and more common for employers to provide their employees with an array of benefit plan choices. When an employee is newly hired or during an enrollment period, employees may be presented with the choice as to whether or not to participate in one or more different benefit categories. Even after deciding to participate in a given benefit category, the employee may then be presented with a choice among particular plans within that category. For example, an employee may be prompted to decide whether to participate in one or more of the following benefit categories: health insurance, vision insurance, dental insurance, supplemental medical insurance, life insurance, disability insurance, condition specific (e.g., cancer) insurance, flexible spending accounts, retirement savings accounts, and/or the like. If the employee decides to participate in the particular category, he/she may also be required to make choices within the category, such as selecting a particular medical plan (e.g., a Health Management Organization (HMO) plan as opposed to a Point-of-Sale (POS) plan), a contribution amount to a flexible spending account, a life insurance amount and term, and the like.

Because of the wide variety of choices available, certain benefits configurations may be more appropriate for some employees than others. For example, an employee without a spouse or dependents may have a reduced need for life insurance compared to an employee with several children, and a high deductible health insurance plan may be more appropriate for a young, healthy employee than an employee with a chronic condition that requires multiple hospital visits in a given year. Similarly, a vision insurance plan may be more appropriate for an employee that requires corrective lenses than an employee that does not. Additionally, employees may be forced to make tough decisions as to how to manage their risk and how to prioritize particular benefits if they have limited funds to allocate to their benefits plans. As such, it may be difficult, if not impossible, for an employee to identify a benefits package that meets the needs of their particular situation. Employees may grow frustrated with the benefits selection process and opt to go with “default” plan choices that are not optimal for their particular situation.

Accordingly, to overcome these problems, example embodiments of the present invention provide flexible and configurable methods, devices, and tools to assist users with selection of a benefits package that meets the needs of the particular user. Embodiments may provide a robust benefits selection platform that queries users for information relevant to the benefits selection process to build a benefits profile for the particular user. The benefits profile is then used in conjunction with a set of parameterized benefits data to determine a set of benefits selections customized for the particular benefits profile. Embodiments may further improve the benefits selection process by converting the user's benefits profile to a narrative presented in natural language, allowing the user to view a plain-language summary of their benefits profile. The user may use the narrative as a starting point to edit or modify their benefits profile to accurately describe the user's needs and personal situation. In some embodiments, the benefits selection platform may further allocate a limited spending allocation among different benefits plans to maximize the benefit to the user from the spending allocation.

As used herein, the terms “data,” “content,” “information,” and similar terms may be used interchangeably to refer to data capable of being transmitted, received, proxied, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

As used herein, the term “benefits plan” should be understood to refer to a particular plan or offering selected to confer a financial benefit to a user or a user's relatives in response to a particular criteria happening to the user or user's relatives. For example, a health insurance plan that pays a user's medical expenses would qualify as a benefits plan, while an extended warranty package for a user's electronic device would not. Similarly, examples of benefits plans may include life insurance plans for the user and the user's family, pension and deferred compensation retirement plans, dental insurance plans, vision insurance plans, long-term and short-term disability insurance, supplemental health insurance plans, flexible savings accounts, health savings accounts, and the like. The term “benefits offerings” should be understood to refer to the possible benefits plans available for selection by users. It should be appreciated that in some embodiments, the benefits offerings may be constrained to a particular user or group of users. For example, certain employees or other groups of users may be grandfathered in to particular benefits plans, or some benefits plans may only be available to particular users upon attaining a certain number of years of service.

As used herein, the term “user” should be understood to refer to any individual utilizing a benefits selection platform to select among one or more benefits plans. While in certain examples within this application the user may be described as an employee of a particular business, it should be readily appreciated that the user may also be a member of a non-business organization that provides benefits plan access to members (e.g., a union or cooperative) or the public at large. For example, the benefits selection platform may be implemented as part of a public health insurance exchange, and the user may be a member of the public purchasing health insurance via the exchange.

As used herein, the term “benefits selection” should be understood to refer to a choice as to whether and how to participate in a benefits plan offered via a benefits selection platform. For example, a benefits selection may include a decision to participate in a medical insurance plan, along with a selection of a particular insurance plan (e.g., a selection of one particular medical insurance plan from a set of plans offered by an employer). Similarly, a benefits selection may include spending allocations or contributions, such as determining whether to participate in a flexible spending account and a contribution amount to said flexible spending account. Benefits selections may be determined programmatically based on inputs from a user, including but not limited to completion of a questionnaire used to derive a benefits profile for the user, with benefits selections for the user then derived using the benefits profile. The user may also be presented with the opportunity to add, reduce or modify benefits selections made programmatically in this manner before the benefits selections are finalized.

### System Architecture

The method, apparatus, and computer program product of the present invention may be embodied by any of a variety of components. For example, the method, apparatus, and computer program product of an example embodiment may be embodied by networked equipment, such as a server or other network entity, configured to communicate with one or more components, which may include one or more edge devices, gateway devices, interfaces, or the like. Additionally or alternatively, the components may include fixed computers, such as a personal computer or a computer workstation. Still further, example embodiments may be embodied by any of a variety of mobile terminals, such as a portable digital assistant (PDA), portable data terminals (PDTs), sensors, readers, mobile telephone, smartphone, laptop computer, tablet computer, or any combination thereof.

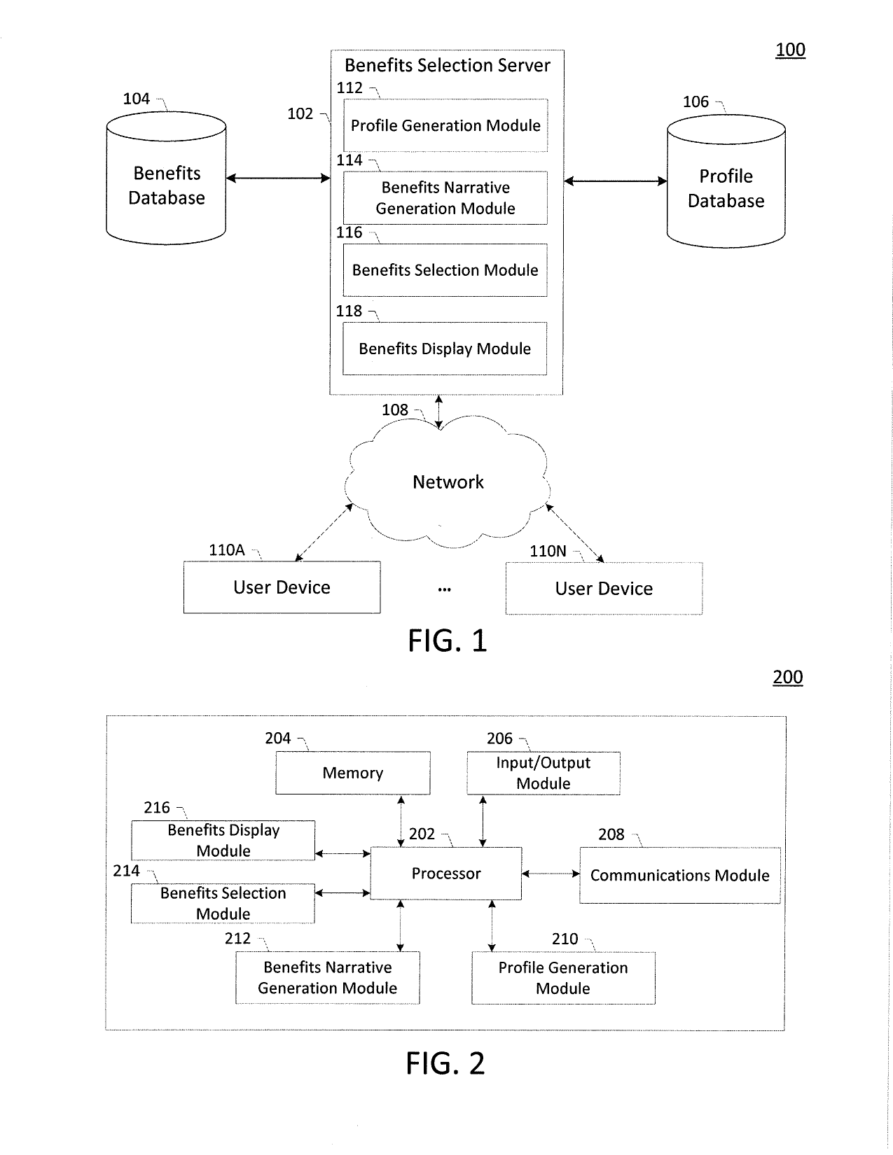

FIG. 1 discloses an example benefits selection platform 100 within which embodiments of the present invention may operate. The benefits selection platform 100 may include hardware and software components to assist a user with making one or more benefits selections from a set of benefits offerings by determining a particular benefits profile for the particular user and comparing the benefits offerings to the benefits profile to create a set of benefits selections appropriate for the user. The benefits selection platform 100 may include a benefits selection server 102 in communication with a benefits database 104, a profile database 106, and one or more user devices 110A-110N.

The benefits selection server 102 may provide various applications, interfaces, tools, and utilities to manage, access, interact with, communicate with, and process information to generate a benefits profile. The operations of the benefits selection server 102 may be enabled by one or more modules to facilitate the benefits selection process, including but not limited to a profile generation module 112, a benefits narrative generation module 114, a benefits selection module 116, and a benefits display module 118.

The profile generation module 112 may support the benefits selection process by generating a benefits profile for a particular user. The profile generation module 112 may generate the benefits profile based on information provided by the user. For example, the benefits generation module 112 may present a questionnaire to a user via one of the user devices 110. The results of the questionnaire may include information sufficient to construct a benefits profile for the particular user, which is then stored in the profile database 106. Additionally or alternatively, the profile generation module 112 may generate a benefits profile for the user based on one or more known characteristics of the user. For example, the benefits profile may be generated based on demographic information captured from the user via one or more forms filled out by the user upon beginning employment, information provided from the results of a pre-employment background check, information provided from the results of a pre-employment credit check, information based on the user's prior year's usage of one or more benefit plans, or the like.

The benefits narrative generation module 114 may support the benefits selection process by generating a natural language narrative based on the benefits profile. This “benefits story” may serve as a brief description of the user's personal situation as it is relevant to the benefits selection process. Presenting the user with their benefits situation in a narrative manner may allow the user to quickly and easily review the inputs used to generate the user's benefits profile and allow for efficient presentation of certain inferences drawn from the user's benefits profile and benefits selections. For example, if the user reads the narrative and disagrees with one or more clauses or phrases, that may serve as a warning to the user that some of the information from which the benefits profile was derived may be erroneous. The benefits narrative may also be used to suggest certain plan selections to the user based on characteristics of the user profile and the benefits plans. Similarly, the benefits narrative may be utilized to identify to the user gaps in their selected coverage or selected coverage that is not a good fit for their benefits profile (e.g., selection of a high deductible plan when the user has little in savings). For example, the narrative may recite the user's family and living situation, provide a brief description of the user's financial status, the user's and the user's family's preexisting medical conditions, and the like. In some embodiments, the user may select a particular clause or phrase from a visual display of the benefits narrative and be taken to an interface for providing updated data to edit or correct the selected portions of the benefits narrative. For example, the user may select a clause relating to preexisting medical conditions and be taken to a question of a benefits questionnaire that allows the user to input preexisting medical conditions.

The benefits selection module 116 may support the benefits selection process by matching one or more elements of a user's benefits profile to particular benefits plans among a set of benefits offerings. The benefits selection module 116 may examine whether certain conditions or risk factors are present in the user's benefits profile and assign a set of benefits selections according to the present conditions or risk factors. The benefits selections may be assigned by comparing the user's benefits profile to a set of benefits parameters stored in a benefits database 104. In some embodiments, the benefits selection module 116 may be operable to determine an expected service usage for the particular user that is provided as input to a cost model used to calculate the expected cost of the particular plan. Benefits selections may be determined at least in part using the cost model. For example, benefits selections may be provided that minimize the overall cost to the user.

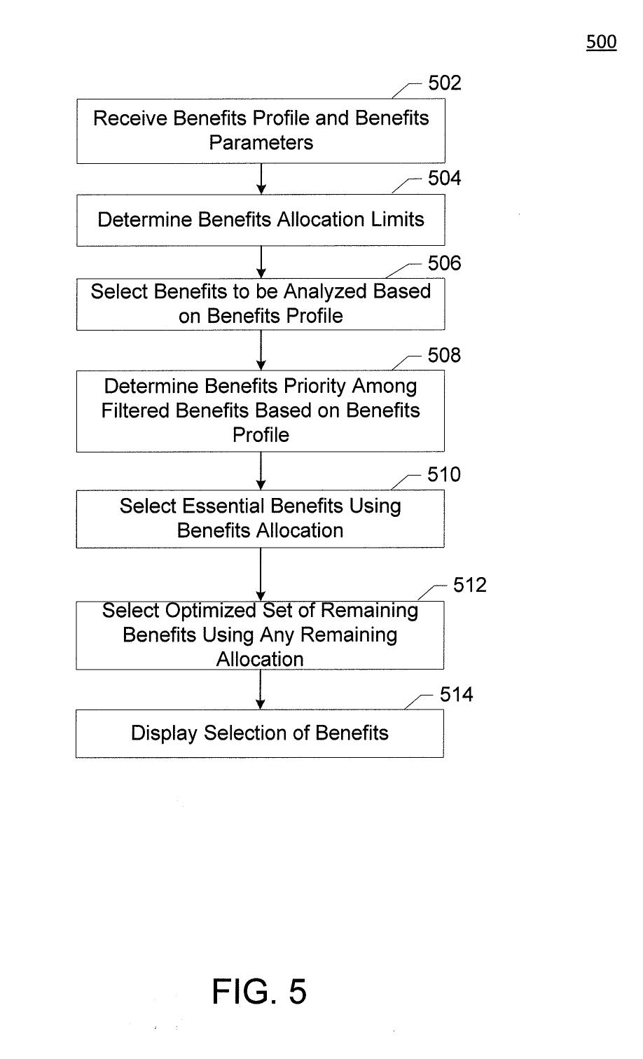

In some embodiments, different benefits plans may be prioritized among the benefits selections based on the benefits profile, such as prioritizing vision coverage if the user requires corrective lenses, prioritizing a dental plan that covers orthodontics if the user has a child that requires braces, or the like. In some embodiments, the benefits selection module 116 may provide benefits selections to the user that cover a set of priority benefits selections, even if the set of priority benefits selections do not minimize the overall cost of the plan. Example methods for determining a set of benefits selections are provided below with respect to FIGS. 5-7.

The benefits display module 118 may support the benefits selection process by displaying to the user the benefits selections chosen by the benefits selection module 116. For example, the benefits display module 118 may provide a web interface allowing the user to view and edit benefits selections. The benefits display module 118 may also display a benefits narrative generated by the benefits narrative generation module 114. The benefits display module 118 may also provide the user with access to an enrollment interface, allowing the user to enroll in the selected benefits.

The benefits selection server 102 may communicate with the user devices 110 over a network 108. For example, the benefits selection server 102 may function as a web server to provide a web-based interface for allowing the user to initiate the benefits selection process. In some embodiments, the benefits selection server 102 may also interface with various benefits provider systems (not shown) via the network 108 to assist with the user's enrollment in the selected benefits. For example, upon confirmation of the user's benefits selections, the benefits selection server 102 may communicate with the benefits provider systems to enroll the user with the selected benefits. It should also be appreciated that in some embodiments the benefits selection server 102 may be incorporated within or as part of a benefits provider system. Although the benefits selection server 102 is described with respect to a “back end” server system, it should be readily appreciated that embodiments may also include client based applications, such as software installed on a client computer, an “app” executing on a mobile device, or the like. For example, a client application may receive the benefits parameters as part of an installation process and processing may happen local to the user device, ensuring that user information is not exposed outside of the client.

The benefits selection server 102 may be embodied by a computing system, such as the apparatus 200 shown in FIG. 2. As illustrated in FIG. 2, the apparatus 200 may include a processor 202, a memory 204, an input/output module 206, a communications module 208, a profile generation module 210, a benefits narrative generation module 212, a benefits selection module 214, and a benefits display module 216. The apparatus 200 may be configured to execute the operations described below. In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the apparatus to carry out various functions in accordance with an example embodiment of the present invention.

The processor 202 may be embodied in a number of different ways and may, for example include one or more processing devices configured to perform independently. Additionally or alternatively, the processor may include one or more processors configured in tandem via a bus to enable independent execution of instructions, pipelining, and/or multithreading.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include an input/output module 206 that may, in turn, be in communication with processor 202 to provide output to the user and, in some embodiments, to receive an indication of a user input. The input/output module may comprise a user interface and may include a display and may comprise a web user interface, a mobile application, a client device, a kiosk, or the like. In some embodiments, the input/output module 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

Meanwhile, the communications module 208 may be any means such as a device or circuitry embodied in either hardware or a combination of hardware and software that is configured to receive and/or transmit data from/to a network and/or any other device or module in communication with the apparatus 200. For example, the communications module 208 may provide an interface for sending and receiving data to and from one or more user devices, such as by providing a web-based interface for benefits selection. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may additionally or alternatively support wired communication. As such, for example, the communication interface may include a communication modem and/or other hardware/software for supporting communication via cable, digital subscriber line (DSL), universal serial bus (USB), or other mechanisms.

The profile generation module 210, the benefits narrative generation module 212, the benefits selection module 214, and the benefits display module 216 may be configured to support the operations of the benefits selection server as described above with respect to FIG. 1. The functionality of these modules is described in greater detail with respect to the example embodiments described below.

### Example Benefits Selection Data Flow

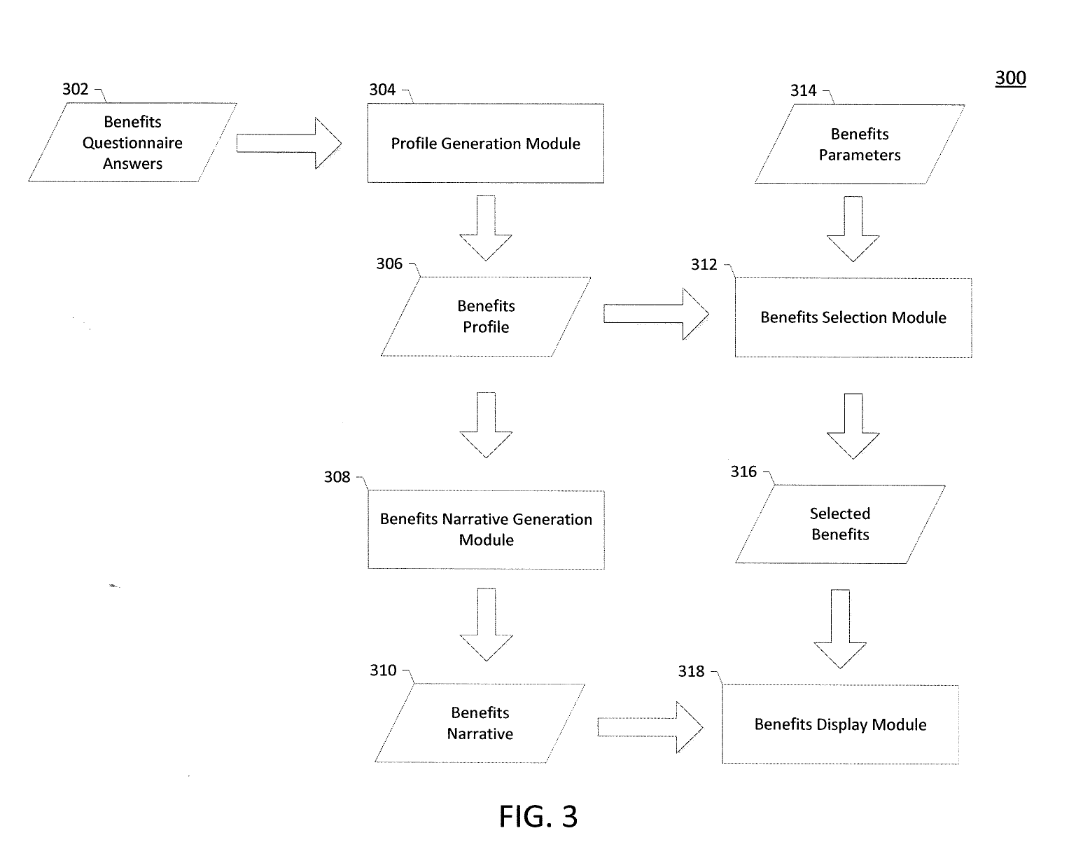

Referring now to FIG. 3, a data flow 300 is illustrated showing an example implementation of a benefits selection process in accordance with embodiments of the present invention. The data flow 300 depicts one embodiment of how input data may be used by a benefits selection platform to assist a user with generating a set of benefits selections. Example embodiments of the data flow 300 may be implemented by the benefits selection platform as described above with respect to FIGS. 1 and 2.

A set of benefits questionnaire answers 302 may be provided as input to the data flow. The benefits questionnaire answers 302 may include answers to one or more questions provided to a user at the beginning of the benefits selection process. For example, a user may be prompted to enter data indicating their age, medical history, number of dependents, desired retirement age, financial stability, and the like. In some embodiments, the contents of the benefits questionnaire may be determined dynamically based on the benefits offerings available. In this manner, embodiments may reduce or eliminate redundant or superfluous questions, thus streamlining the data input process for the user. For example, if the benefits offerings do not include a vision insurance plan, then the benefits questionnaire may not include questions directed to whether the user requires corrective lenses. For example, for each particular plan type and/or features offered by a particular plan, a comparison may be made to a question matrix. The question matrix may include questions that are keyed to particular plan types and features. If an offered plan type or plan feature matches a flag set for a particular question in the question matrix, the question may be added to the questionnaire presented to the user. For example, the presence of a life insurance offering may trigger inclusion of questions related to whether the user has a mortgage, children, and a particular savings account balance. Questions may be deduplicated to ensure that each question is only answered once. In some embodiments, questions that have already been answered prior to generation of the question profile (e.g., questions with answers provided by a background check or via a user personnel file) may be identified so as not to ask the user for redundant information. In some embodiments, information gathered prior to the questionnaire may be presented to the user for confirmation.

The benefits questionnaire answers 302 are provided to a profile generation module 304. The profile generation module 304 may analyze the benefits questionnaire answers 302 to generate a benefits profile 306 for the user. The benefits profile 306 may be constructed as a data structure with different fields for different values that are relevant to selection of one or more benefits plans. In some embodiments, the structure of the benefits profile may be dynamically configurable based on the benefits offerings available. For example, particular fields or variables may be added to the benefits profile 306 based on the presence or absence of particular benefit plans or types of benefit plans. The benefits profile may include various attributes of the user as relevant to the user's benefits selection and as obtained via the benefits questionnaire or through other means. For example, the benefits profile may include data indicating the user's marital status, the user's age, the user's medical conditions, the user's past medical history, whether the user requires corrective lenses, whether the user has dependents, the user's overall risk tolerance, the user's retirement planning strategy, the user's current assets, the user's salary, whether the user has a mortgage, the user's monthly debt payments, or the like. In some embodiments, the benefits profile may have one or more of the following properties:

TABLE 1

| Property | Description |
|---|---|
| Loss Of Pay | Length of time family could comfortably live without the |
| | employee's income |
| Cost Sensitivity | Importance of limiting recurring out of pocket spending on |
| | benefits |
| Retirement Planning | Importance placed on saving for retirement |
| HSA Balance | Current balance in the family HSA |

Obligations

| | |
|---|---|
| Mortgage | Flag indicating if family has a mortgage |
| Total Debt | Total amount of family debt |
| Avg Monthly Payments | Average payments on all loans, credit cards, and other debts |

Events

| | |
|---|---|
| Pregnancy | Flag indicating if 1+ family members likely to get pregnant |
| | and/or give birth in the coming year. |
| Orthodontics | Flag indicating if 1+ individuals will have braces in the coming |
| | year. |
| Move | Information describing any moves in the coming year |

History

| | |
|---|---|
| Cancer | Flag indicating if 1+ members have a family history of cancer |

Alternate coverages (may need per family member)

| | |
|---|---|
| Type | Benefit type |
| Amount | Amount of coverage |
| Satisfied | Satisfaction level with coverage |

Individual data

| | |
|---|---|
| Role | Employee, spouse, dependent |
| Annual income | Annual income to be applied towards benefits calculations |
| DOB | Date of birth |
| Health rating | 1-5 stars |
| Location | Residence location for insurance purposes |
| Smoker | Flag indicating if person smokes |
| Corrective Lenses | Flag indicating if person requires vision correction |
| Issues | Medical issues affecting this person |

The benefits profile 306 may be provided as input to the benefits narrative generation module 308. The benefits narrative generation module 308 may generate a benefits narrative 310 that includes narrative description of the user's benefits profile to provide the user with a straightforward description of the user's inputs that were used to generate the benefits profile. This benefits narrative 310 may be used by the user to quickly verify that the contents of the benefits profile match their understanding of their particular situation and to efficiently convey certain inferences based on the user's profile and the possible benefits offerings. The benefits narrative may advantageously provide a rephrasing of the user's benefits profile and/or benefits selections to assist the user with consideration of their benefits selections in a format other than raw numerical data. The benefits narrative generation module 308 may include one or more natural language generation systems as known in the art. For example, the benefits narrative generation module 308 may match particular elements of the benefits profile (e.g., particular flags or variable values) to particular phrases, clauses, sentences, or the like to be used in generating the benefits narrative. The benefits narrative generation module 308 may also perform various natural language generation techniques, such as aggregating terms (e.g., generating a comma delimited list of user medical conditions), prioritization and selection of particular phrases and clauses, and post-processing to improve readability.

Elements of the benefits narrative may also be presented in an interactive manner, allowing a user to select a particular term or phrase and be routed to an interface for editing the particular portion of the benefits profile linked to the selected term or phrase. For example, the user may select the phrase corresponding to a particular medical condition to be taken to a portion of the questionnaire associated with the user's medical history, whereby the user may then edit the medical history. Additionally or alternatively, terms and phrases of the benefits narrative 310 may be linked to particular user benefit selections. For example, if the user alters benefits selections in a manner inconsistent with the benefits narrative (e.g., dropping vision coverage when the user requires corrective lenses), then a portion of the benefits narrative stating “User wears corrective lenses” may be highlighted (e.g., color coded, underlined, or the like). The benefits narrative 310 may be provided as input to a benefits display module 318 for such interface and display functionality. The benefits display module 318 may also allow for display and editing of user benefits selections as chosen by a benefits selection module 312.

The benefits selection module 312 may receive the benefits profile 306 and a set of benefits parameters 314 as input. The benefits parameters 314 may include information identifying particular values associated with various benefit plans. For example, medical insurance benefit plan parameters might include flags for different types of benefit offerings (e.g., pregnancy coverage, no-referral requirement for specialists, whether particular doctors are in the insurance network, whether particular hospitals are in the insurance network, which company underwrites the policy, which medications are covered by the plan), deductible amounts, coinsurance amounts, copayment amounts, out-of-pocket maximum amounts, premiums, and the like. Vision insurance benefit plan parameters might include an annual corrective lenses allowance, copayment amounts, coinsurance amounts, premiums, and the like. Life insurance benefit plan parameters might include term limits, award amounts, whether certain types of death are covered, and the like. Disability insurance plan parameters might include durations, payment information, premiums, and the like. It should be readily appreciated that various types of benefits may have various additional or alternative parameters that may be relevant to the particular benefit types as they may be applied to the user's particular benefits profile. In some embodiments, the benefits parameters 314 are provided as one or more files in a markup language, such as extensible markup language (XML), with different plan parameters stored in a hierarchical format.

The benefits parameters 314 may also include one or more service cost tables. The service cost tables may define the likely costs for different services associated with the particular benefit plan, such as common medical procedures for a medical plan, dental procedures for a dental plan, corrective lenses prices for a vision plan, or the like. In some embodiments, each benefits plan may be associated with a particular service cost table reflecting the plan's particular negotiated prices for various procedures. In some embodiments, a single service cost table is employed to be used for each benefit plan in order to provide an objective evaluation of the plan benefits.

The benefits selection module 312 may be programmed to apply particular analyses to different types of benefits based on one or more rules for that particular benefit type. For example, the user's medical history may be used for an analysis of a medical insurance plan, but not for evaluation of an accidental death insurance plan, and whether the user requires corrective lenses may be relevant for evaluating a vision insurance plan, but not for a life insurance plan.

The benefits selection module 312 may also be operable to prioritize certain benefits. Prioritization may be performed based on the contents of the user's benefits profile. For example, users that have no dependents or a spouse that earns a significant income may have a lower priority placed on life insurance than other users. The benefits selection module 312 may evaluate the available benefits offerings according to these priorities, such in case cases where the user has insufficient assets or means to purchase a comprehensive benefits package. As such, the benefits selection module 312 may include an evaluation of which benefits are the highest priority for the user (e.g., programmatically determine a ranked list of benefits for the user), and assign an available spending allocation to those benefits first (e.g., based on the ranked list), with the remainder of the allocation assigned to other, lower priority benefits. The benefits selection module 312 may generate an output set of selected benefits 316, representing an initial assignment of benefits optimized for the particular user associated with the benefits profile. The selected benefits 316 may be sent to the benefits display module 318 for display to the user and to allow the user to view and edit the benefits selections. The selected benefits 316 may be presented in conjunction with the benefits narrative 310 to assist the user with understanding and editing the benefits selections.

### Example Benefits Profile Generation Operations

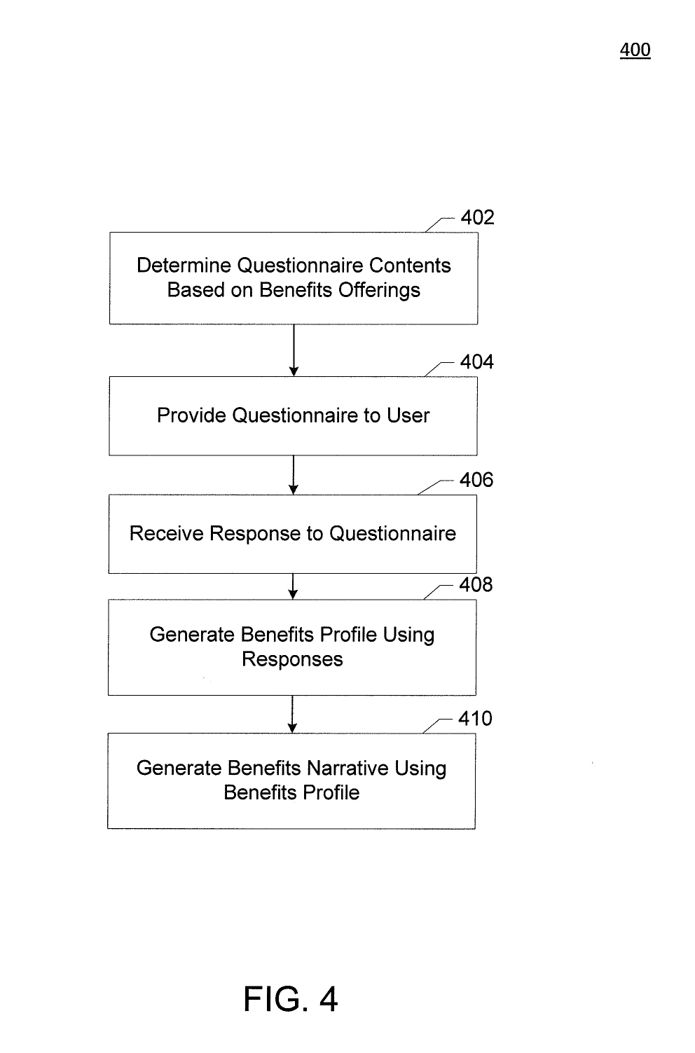

Turning now to FIGS. 4-7, example operations for performing benefits selection operations are illustrated from the perspective of a benefits selection server. The operations illustrated in FIG. 4-7 may, for example, be performed by the profile generation module 210, the benefits narrative generation module 212, the benefits selection module 214, and the benefits display module 216, alone or in concert with one another or with other elements of a benefits selection platform with the assistance of, and/or under the control of one or more devices, such as the apparatus 200. For example, the methods and processes depicted herein may be executed by a processing means, such as the processor 200, to perform one or more aspects of the benefits selection process.

FIG. 4 depicts a flow diagram illustrating an example method 400 for generating a user benefits profile. As described above, the user's benefits profile may be used throughout the benefits selection process to match the user with a set of benefits selections appropriate for the user. This matching process may include determining information about the user relevant to the benefits selections and determining a priority for allocating user benefits selections. The method 400 describes one example process for obtaining the information used to build this benefits profile. Although the present example method relates to the use of a benefits questionnaire that is dynamically tailored based on a set of benefits offerings, it should be appreciated that various other methods could also be used to gather user information for generating the benefits profile, including but not limited to accessing a user personnel database, accessing user medical records (e.g., from an electronic medical records system to which the user allows access), or using a questionnaire that is not determined based on the benefits offerings.

At action 402, the method 400 may determine a set of questionnaire contents based on the available benefits offerings. As described above, the questions included in the questionnaire may be tailored based on which benefits are to be evaluated for the particular user. For example, an unmarried male user may have questions regarding possible pregnancies removed from the questionnaire, or a company that does not offer life insurance may have questions related to a desired life insurance term and mortgage status removed from the questionnaire. It should be appreciated that a given dynamic questionnaire may be tailored at various different levels. For example, a questionnaire may be tailored to an individual user (e.g., based only on the benefits offered to that specific user, excluding benefits offered to other users at the same organization), or to an organization (e.g., based on the total benefits offerings provided by the organization). In some embodiments, the user may fill out a questionnaire one time (e.g., during account registration), and the results of the questionnaire may be associate with the user's account. If the user's personal benefits situation changes, the user may opt to redo the questionnaire or portions of the questionnaire. In some embodiments, the user may be prompted to ask if any changes have occurred to the user's situation upon accessing the benefits selection system. In yet further embodiments, selection of particular benefit types or packages may cause additional questions to be presented to the user. In still yet further embodiments, selecting certain answers to particular questions may cause additional questions to be presented to the user.

At action 404, the questionnaire is provided to the user. The questionnaire may be provided in various formats, including but not limited to generating a web page form, sending the user an e-mail either formatted to accept responses or with a link to a web interface, generating a paper copy of the questionnaire to be mailed to the user, or the like.

At action 406, a response to the questionnaire is received. The response may be provided in any manner suitable for receiving the relevant data by a computer system. For example, the response may be provided by a web form, via an e-mail (e.g., parsed directly from an e-mail response), based on scanning or other electronic processing of a paper form, based on data entries provided by a processor that receives a hard copy of the form, or the like. At action 408, the responses to the questionnaire are processed to generate a benefits profile, which may include a list of flags and variables that are relevant to matching the user to a particular set of benefits selections chosen from the benefits offerings provided by an organization, employer, or the like maintaining the benefits selection platform executing the process 400.

At action 410, the benefits profile may be used to generate a benefits narrative describing the contents of the benefits profile in natural language. As described above, the terms and values of the benefits profile may be matched to particular phrases and clauses that provide a general description of the user's personal and financial situation as it relates to selections to be made from the benefits offerings. These terms and phrases may be processed to generate natural language that describes the user's unique circumstances in a clear, concise manner.

### Example Benefits Selection Operations

FIG. 5 depicts a flow diagram of an example method 500 for determining benefits selections for a user given a set of benefits parameters and a user benefits profile. Given a set of priorities and needs determined from the user benefits profile, the method 500 may operate to assign a given user benefits allocation among one or more different benefits plans in a manner so as to best meet the needs of the user.

At action 502, the method begins by receiving a set of benefits parameters and a benefits profile for a particular user. The benefits parameters may correspond to a set of benefits offerings available via the benefits selection platform (e.g., a set of benefits offerings offered by a company to the company's employees). In some embodiments, the benefits parameters are provided according to a common parameterization format from a provider offering the benefits plan, while in other embodiments the benefits parameters may be entered manually by an administrator of the benefits selection platform. As described above with respect to FIG. 3, the benefits parameters may include data describing the different features, benefits, premiums, and the like for each different benefit plan.

At action 504, limits for the user's benefits allocation may be determined. The benefits allocation may generally be considered as a “budget” to be applied to the different benefits offerings provided via the benefits selection platform. This budget may be determined based on various factors, including but not limited to information stored within the user's benefits profile (e.g., whether the user is engaged in retirement planning or has a certain income level), information provided by an organization (e.g., the user's employer), certain plan restrictions associated with the available benefits offerings, or various other factors. For example, a user may specify an annual salary and expected expenses as part of a response to a questionnaire, and the benefits allocation may be determined based on these values. Additionally or alternatively, an organization may indicate a particular employer contribution to be used as the benefits allocation. In some embodiments, the user may be prompted as to whether they wish to contribute additional funds to the benefits allocation above and beyond the employer contribution.

At action 506, a subset of the benefits offerings may be selected based on the user's benefits profile. Selecting a subset of the benefits offerings allows for filtering of benefits plans in which the user has no interest or no need (e.g., removing “family” medical insurance plans when the user has no spouse or children) from the selection process.

At action 508, a benefits priority may be determined based on the benefits profile. The benefits priority may define an ordering of different benefits types based on which benefits types are determined to be most important to the particular user. A rules engine may analyse the user's benefits profile to determine which benefits the user is most likely to need given the user's unique situation by matching particular elements of the benefits profile (e.g., user age, dependents, financial reserves, and/or medical conditions) to particular criteria for certain benefit types. For example, a vision insurance plan may be flagged as high priority if the user requires corrective lenses, so the rules engine may check the user benefits profile for a flag associated with corrective lenses. If the flag is present, then the priority level for a vision insurance benefit plan may be increased. Similarly, if the user profile indicates other special needs (e.g., a chronic condition, a high risk of an inheritable illness, or the like), then benefit plans corresponding to those special needs may be increased in priority. In some embodiments, multiple flags may control whether a particular benefit is essential. For example, a dental plan that offers orthodontic coverage may be flagged as essential if the user requires braces or has a child that requires braces, and the user's savings do not allow them to skip more than one or two pay checks, representing the financial hardship that would result from having to purchase an orthodontic device out-of-pocket.

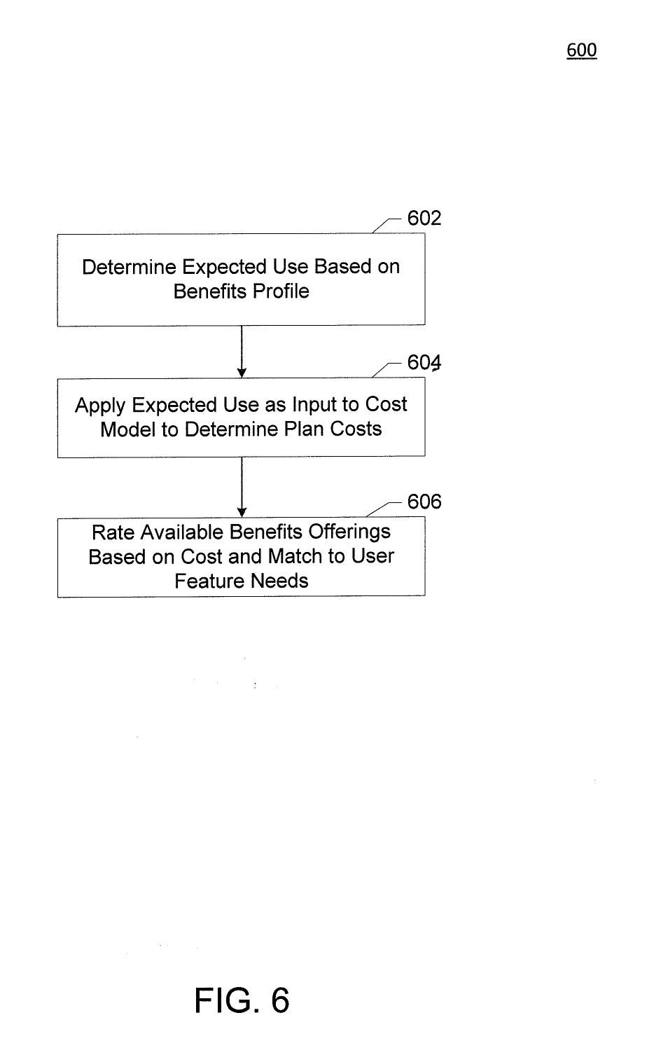

At action 510, certain “essential” benefits may be selected. These essential benefits may correspond to the high priority benefits identified at action 508. The benefits selection algorithm may rate particular benefits selections based on the user's benefits profile, and allocate spending form the user's benefits allocation to the essential benefits with the maximum rating. A method for rating particular benefits selections is described further below with respect to FIG. 6. By selecting essential or high priority benefits first, the method may ensure that the user's benefits allocation is first directed to the most important benefits for the user's particular situation.

At action 512, the method selects an optimized set of remaining benefits using any remaining budget allocation. This allocation may be performed by rating each of the remaining benefits plans based on the user's benefits profile, and assigning the remaining allocation to the plans with the highest rating. If the user has not exhausted their benefits planning budget on essential benefits, the method may attempt to determine additional benefits that will be of use to the user despite not having a top priority due to the user's particular situation. For example, the method may notify the user of the desirability of additional benefits plans (e.g., disability insurance), even if the user is not identified as having a particularly high risk or need of such plans. In a scenario where the user's available budget is insufficient to fund all benefits indicated as essential, then the benefits may still be selected, but a warning presented to the user indicating they are over-budget, or allocations may not be made beyond the user's budget. Benefits may still be allocated according to a defined priority, even among essential benefits. Alternatively or additionally, if two benefits are associated with the same priority, one may be randomly chosen to break a tie in the case of an insufficient budget. In some embodiments, additional selections may even be made if the budget is exhausted, such as in the case of a user HSA where the user may wish to open the HSA but not immediately make any contributions.

At action 514, the benefits to which the user's funds are allocated are selected and presented to the user for viewing, editing, and confirmation. Benefits displayed in this manner may be marked to indicate their priority level or status as essential benefits. The display of these benefits may also include a description of the premium costs of each benefit, the final cost to the user, and how much of an employer contribution the user received. The user may provide an input to confirm the benefits selections, which may trigger enrolment in each of the selected benefits plans.

FIG. 6 depicts a flow diagram of an example method 600 for rating benefits selections. As described above, different benefits plans may be more appropriate for certain users than for others. In order to match a given user's benefits profile to a particular benefits plan selection, a ratings system may be employed. In consideration of which benefits plan is proper, the method 600 may account for both how closely the benefits of a given benefits selection meet the needs of the user (e.g., full coverage of categories the user requires) and the price efficiency of the benefits selection (e.g., the total expenses required to gain the coverage, including premiums, co-payments, coinsurance, and the like).

At action 602, the user's expected plan use and set of user feature needs are determined based on the user's benefits profile. The expected use may attempt to model the user's likely use of a particular benefits plan over a particular period of time (e.g., over a year). For example, for a medical plan, the expected use may estimate the number of times the user is likely to visit their primary care doctor, specialists, the emergency room, and the like. For a dental plan, the expected use may estimate the number of times the user has their teeth cleaned, a filling inserted, or the like.

The expected use may be expressed as a set of health plan services used by a given user or user's family over a period of time. Each service may specify an applicable health plan feature (e.g., coverage types), a lookup key in a services cost table, and a likely number of times the particular service is utilized. The expected use may be determined based on past medical history of the user, the user's benefit profile, population demographic information, or any combination thereof. Additionally or alternatively, the method 600 may provide the user with the ability to develop custom scenarios and to manually specify certain required coverages and cost scenarios in order to view the impact on the benefits plan selections. In some embodiments, a model population is used to determine the expected use. The model population may be divided into various groups or “buckets”, such as based on an annual provider reimbursement amount.

Service counts for a particular user may be calculated based on the user's benefits profile. In some embodiments, the profile contains health rating information with a ranking system that places the user in a particular tier or tiers for their health rating. The health rating is then mapped to a particular expected count of each service to be utilized in a given time frame. Service counts may be further organized into brackets based on the age and sex of the users. The health rating of each member of the user's family and the age and sex of the member of the user's family may be used to determine a mapping to a count for each particular service. This count may then be applied as the expected use of that service for that family member as part of the expected use.

At action 604, the expected use may be applied as input to a cost model in order to evaluate the various plan offerings. As described above with respect to FIGS. 1-5, each of the plan offerings may be parameterized to allow for easier input to a cost model. These parameters may include descriptors for each possible feature offered by the plan. Each feature may include values relating to cost, coverage, and the like. For example, cost values may include the deductible associated with the feature, the out of pocket maximum for the feature, the co-payment for the feature, or the like. The coverage values may include functions indicating whether the feature is covered completely, covered after a combined deductible, covered after a feature-specific deductible, covered with a co-payment, or not covered. Example health insurance features that may be offered by a particular insurance plan may include, but are not limited to, primary care visits, specialist visits, primary visits (inpatient), specialist visits (inpatient), primary outpatient, specialist outpatient, preventive care, routine vision (eye exam), diagnostic services (inpatient), laboratory services (inpatient), pathology (inpatient), x-ray services, diagnostic services (outpatient), laboratory services (outpatient), pathology (outpatient), x-ray (outpatient), maternity care, physical rehabilitation, speech therapy, spinal manipulations, acupuncture, hospital care, emergency care, ambulance services, alcohol and drug abuse counseling, severe mental illness, supplies, equipment, and appliances (inpatient), supplies, equipment, and appliances (outpatient), home care, chemotherapy, haemodialysis, radiation therapy, hospice care, skilled nursing facility, human organ and tissue transplant, temporomandibular joint syndrome (TMJ), and enteral formula and special foods. Example prescription medication benefit features include tier 1—generics, tier 2—preferred branded, tier 3—non-preferred branded, and tier 4—specialty. Each feature for each benefit plan may be associated with a particular cost function for calculating the cost of a service using that feature. For example, parameters for a given benefits plan may indicate that primary care visits are covered at no charge (e.g., a no charge function for services associated with a primary care visit), while emergency room visits are associated with a $50 co-payment (e.g., a co-payment function with a value of $50 associated with services handled as part of an emergency room visit).

The cost model may receive the expected usage of the user and the parameters associated with each available plan offering as inputs, and determine a likely cost to the user for each plan. The cost model may further receive a set of service costs associated with the benefits offerings. In some embodiments, the set of service costs is a single table, while in other embodiments the set of service costs is different for each benefit plan. For example, the set of service costs may reflect the costs for common services as negotiated by each separate benefit plan.

A given service cost table may contain entries for low-level procedures such as an x-ray, a visit to an out-patient facility, or a primary care physician visit. In the event the user requires medical treatment, they will likely require some combination of services listed on the service cost table. Embodiments may associate particular sets of services with particular medical issues which may be presented in various levels of abstraction. For example, a medical issue may be general (e.g., inpatient procedure or emergency room visit) or specific (e.g., fibromyalgia or type one diabetes). Each medical issue may be associated with particular services based on the services that are typically performed in response to that issue. A cost for a given issue can be determined by selecting a number of issues, assembling the services associated those issues, and applying the coverages defined in the benefits parameters for the assembled services.

The cost model may determine a cost for each benefit plan by performing a reduce function on each service that the user is identified as likely to use. In some embodiments, a seed value for the reduce function is selected using an accumulator object containing a total value spent by a consumer, including premiums and subtracting the employer's contribution, and the amount paid towards each deductible and out of pocket maximum. Each service may be dispatched to a particular feature cost function that performs the logic of adhering to plan specifications using accumulator functions, where the cost function applied for each service is determined based on the parameters of the particular benefit plan being analyzed. The accumulator functions may be specialized for determining the amount an insurance policy will cover and what the consumer must pay. Depending upon whether each benefit plan covers the particular condition, different values may be added to the cost calculated for the particular issue for the particular benefit plan. For example, certain services may not have any associated charge, while other services may require a copayment. Embodiments of the invention may model the impact of these charges on the total cost, taking into account the effect of any deductibles, out of pocket maximums, copayments, and the like.

In order to rate the benefits plans analyzed by the cost model, embodiments may take into account factors other than the expected cost. For example, a plan that minimizes the user's cost but does not account for possible catastrophic conditions that are unlikely, but devastating if they occur, may be less optimal than a more expensive plan that provides more complete feature coverage. Other factors may include whether the plan allows for the ability to choose a doctor without permission from the plan provider, the premium of the plan, whether the plan is compatible with an HSA, and the like. As such, at action 606 the method may rate plans based on not only the expected annual cost to the user, but also based on the coverage provided by the plan. In one specific example, these values may be determined as follows:

Cost Value: The annual cost may be converted to a number from 0 to 10. For example, the lowest cost plan may be given a score of 10. Other plans may be scored based on the difference in price with the lowest cost plan. A gradient may be calculated by taking the greater of 1) dividing the cost of the cheapest plan by 10 and 2) dividing the difference of the cheapest and most costly plans by 10. The cost value for each plan may be then computed using the formula: max(10−((planCost−cheapestPlanCost)/gradient), 0)

Feature Coverage Match Value: Important plan features may be obtained from the user's benefits profile. A plan may be given one point for each desired feature supported. Possible features of interest in include having a doctor in network, rules for choosing a doctor, whether the premium amount is not covered by employer, medicine cost, and the like. The score is then normalized to the range of 0 to 10 based on the max number of points.

The score for the cost value and the feature coverage match value may be weighted equally and averaged together to determine a rating for the particular benefits plan. The benefits plan with the highest rating may be selected by the method as a benefits selection for the user to be displayed to the user as a plan suggestion.

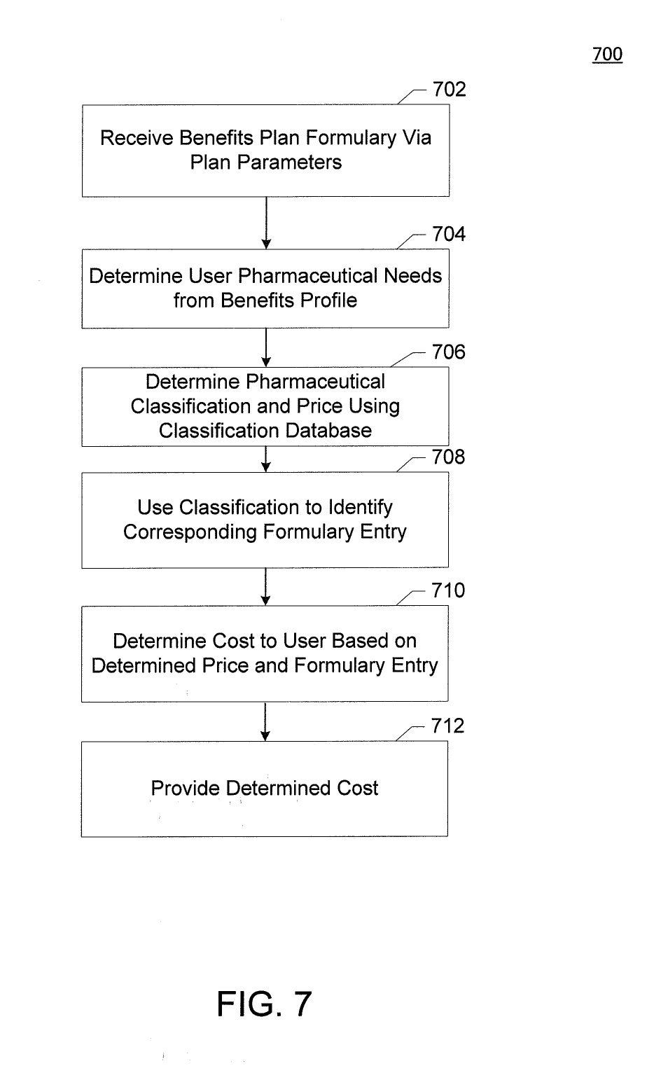

FIG. 7 illustrates a flowchart depicting an example method 700 for using a pharmaceutical search to estimate benefits costs and provide benefits selection recommendations. Many users may require particular medications or pharmaceuticals on a frequent or recurring basis. However, since different plan offerings provider different coverage levels for particular medications, it may be difficult to estimate the cost for each medication under a particular plan. For example, a particular provider may provide limited coverage for a brand-name medication, but full coverage for corresponding generic medication. The method 700 may be employed during a benefits selection process as described above with respect to FIGS. 1-6 in order to accurately estimate pharmaceutical costs to a user for a particular pharmaceutical across different benefits plans and/or providers.

At action 702, a benefits plan formulary is received via the plan parameters associated with the particular plan. For example, the formulary may be included in a file or files for the particular plan, or the plan parameters may include an external link to a database containing the formulary. The formulary may include a listing that specifies the insurance company's and member's share of the cost for various medications and medication types (e.g., generic, single-source brand, multi-source brand, preferred brand). The formulary may also indicate special circumstances for certain medications (e.g., medication qualifies for mail order), and a list of particular preferred brand medications that may have a lower member cost share because of rebates provided by the manufacturer to the insurance company.

At action 704, a set of user pharmaceutical needs is determined. This set of needs may include prescriptions currently or previously used by the user or other individuals covered by the user's policy, medications likely to be used by the user or other covered individuals based on the user or individual's medical history, or the like. The set of needs may also include an indication of whether the user has a preferred brand of a particular medication, whether the user is willing to use a generic of a particular medication, or the like.

At action 706, a classification for one or more medications specified by the user's needs is determined using a medication classification database. For example, a user may have indicated they have a prescription for a particular medication. This particular medication may be looked up in a medication classification database, such as Medi-Span® or First DataBank®. The medication classification database may identify whether the particular medication is a brand name medication, a generic medication, or the like. The database may also identify whether there is a generic alternative to a particular brand name medication, or vice-versa. The database may, for example, identify an average wholesale price for the medication, identify a manufacturer's suggested retail price for the medication, identify an average price for the medication, identify the manufacturer of the medication, or provide other information about the particular medication.

At action 708, the method may use the information obtained from the medication classification database to determine the appropriate formulary entry for a benefits plan. The formulary may indicate the costs associated with each particular type of medication, which manufacturers are preferred manufacturers, and the like. For example, the formulary may indicate that generic medications have a $5 copayment, preferred brands from particular manufacturers have a $25 copayment, and non-preferred brands are not covered. The information retrieved from the medication classification database may be used to identify the extent to which the particular pharmaceutical needs specified by the user are covered by the particular benefit plan.

At action 710, a cost to the user is determined using the information identified within the medication classification database and the corresponding formulary entry. For example, if the medication is covered by the benefits plan, then a cost may be determined based on the copayments or coinsurance associated with the particular type of medication. Alternately, if the medication is not covered, then a cost may be determined based on a price for the drug as determined from the database, such as the average wholesale price of the medication. In this manner, the method may dynamically determine how to calculate the price of each pharmaceutical required by the user using the coverage information provided as part of the benefits parameters and the information stored in a medication classification database. The method therefore advantageously takes into account both the price of a particular medication and the coverage levels of particular insurance plan to assist with the evaluation of the total cost to the user.

In some embodiments, the cost to the consumer may be determined by performing trial adjudication with a pharmacy system. For example, embodiments may interface with a pharmacy gateway system and generate a trial claim for the particular medication using a particular insurance system. The trial adjudication may provide the actual price for a medication as if the claim were submitted under the benefit plans that the user is evaluating. Depending on the pharmacy benefit of each benefit plan, the medication cost may vary by the retail or mail location. As such, embodiments may provide the price of the medication on a map within a proximity of the user so that the user can evaluate the cost of the medication at various pharmacies near them.

At action 712, the cost determined at action 710 is provided. In some embodiments, the cost may be provided directly to the user to inform the user. Alternatively, in some embodiments the cost is used as a component of a cost estimation of a particular insurance plan to assist with performance of a benefits selection operation as described above with respect to FIGS. 1-6. For example, the pharmaceutical cost of each benefits plan for the user's pharmaceutical needs may be one component of a cost model used to determine a total cost to the user for each plan offering.

### Example Benefits Narrative Utilization

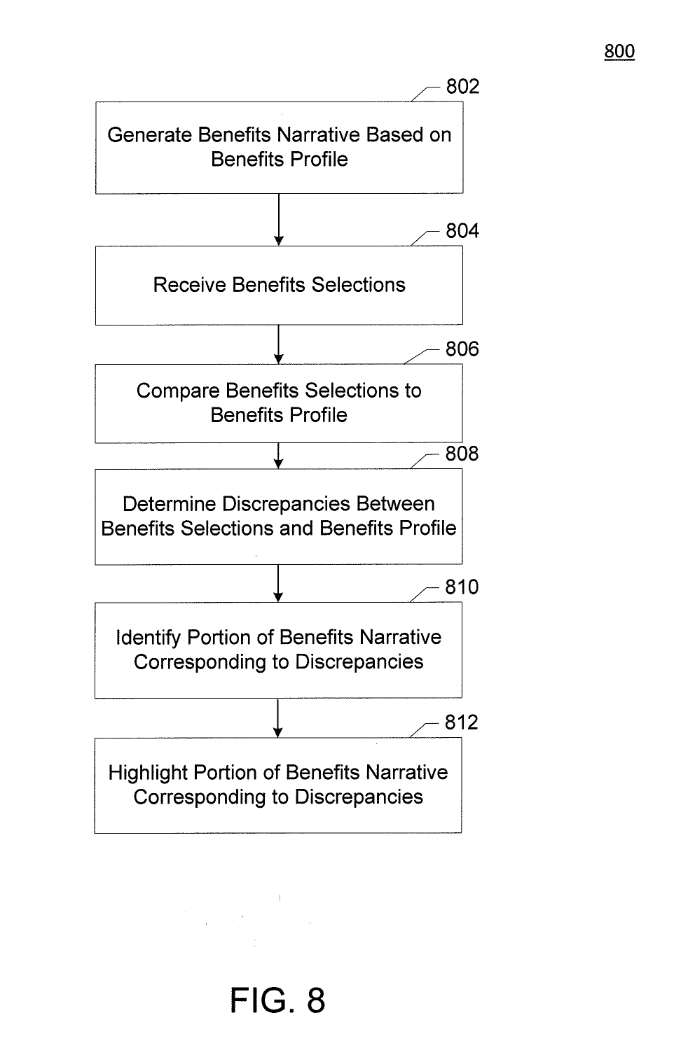

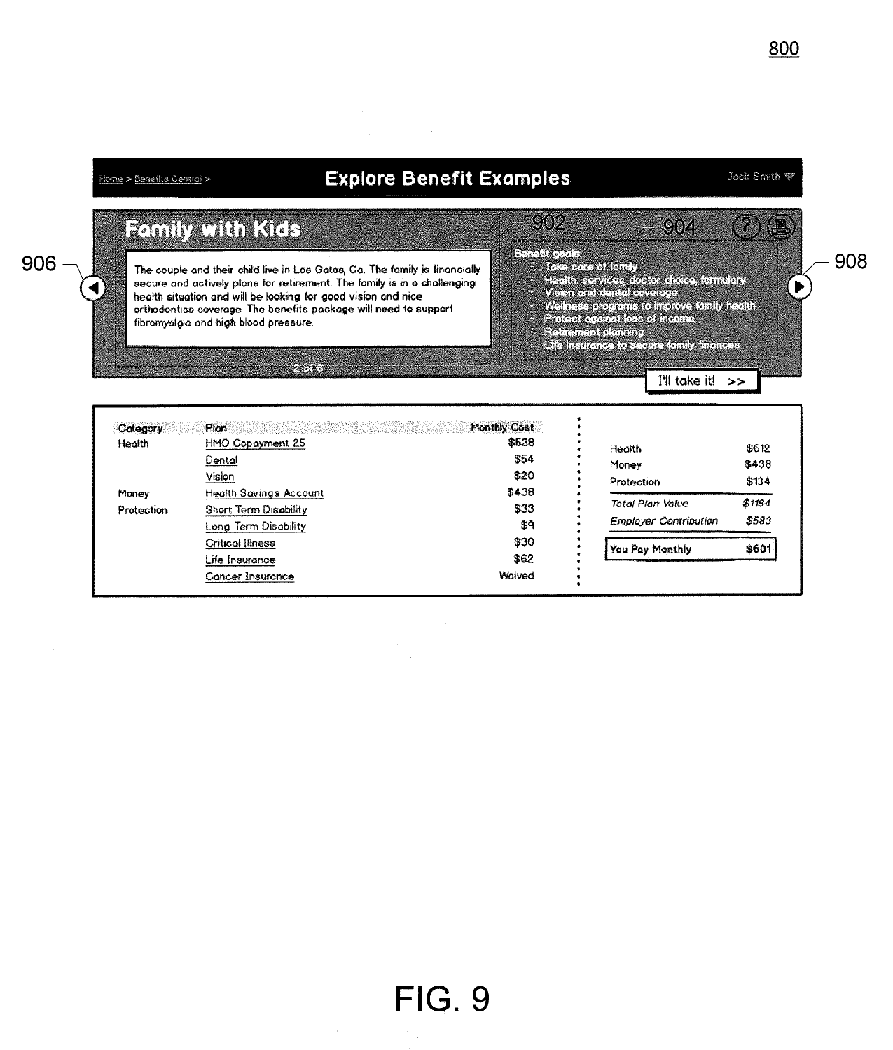

FIG. 8 illustrates a flowchart depicting an example method 800 for using a benefits narrative to assist a user with the benefits selection process. As described above with respect to FIGS. 1-3, embodiments may generate a natural language narrative based on the user's benefits profile. This narrative may describe the particular situation of the user in a clear, easily understandable manner that allows the user to understand why particular benefits were selected for the particular user. The method 800 illustrates one example use of this benefits narrative, whereby portions of the benefits narrative are highlighted for the user based on particular benefits selections. Example interfaces for using a benefits narrative to assist with the benefits selection process are described further below with respect to FIGS. 9 and 11-15.

At action 802, a benefits narrative is constructed for the user based on their benefits profile. As described above, the benefits profile may include several sentences or paragraphs describing information contained within the user's benefits profile as it pertains to the user's benefits selections. At action 804, a set of benefits selections may be received for the user. The benefits selections may be received programmatically. For example, the benefits selections may be automatically selected based on the user's benefits profile, as described above with respect to FIGS. 3-7. Alternatively, the benefits selections may be received directly from the user, such as input via a benefits selection interface.

At action 806, the benefits selections are compared to the user's benefits profile. For example, the benefits profile may be analyzed to determine how well the benefits selections match with features of the benefits profile. At action 808, any discrepancies between the benefits selections and the benefits profile are identified. For example, if a user's benefits profile indicates the user requires corrective lenses, but the benefits selections do not include enrollment in a vision plan, then this may be identified as a discrepancy.

At action 810, the portions of the benefits narrative corresponding to the discrepancies are identified. For example, one or more terms, clauses, or phrases corresponding to the portions of the benefits profile that were identified as discrepancies may be selected by the method 800. To continue the vision plan example from action 808, a portion of the narrative reading “You require contact lenses” may be identified as associated with the discrepancy. At action 812 the portion of the benefits narrative corresponding to the discrepancy may be highlighted. For example, the sentence or phrase may be colored or underlined. In some embodiments, when the user places the cursor over the benefits narrative, benefits selections that are associated with the portion of the narrative on which the cursor is placed may be highlighted. For example, when placing the cursor on a portion of the narrative related to the user's number of dependents and home mortgage, a benefits selection relating to selection of a life insurance policy may also be highlighted. Additionally or alternatively, the highlighting feature may be used to point out areas in which the user should rethink their benefits selections, such as by highlighting in red portions of the narrative that the currently selected benefits selections do not satisfy. In some embodiments, selection of a portion of the narrative may prompt the user with an interface to alter their benefits profile. For example, selecting a particular sentence of the benefits narrative may allow the user to alter the answers to the original questionnaire that are associated with the portion of the narrative that was selected.

### Example Benefits Template Usage

FIG. 9 illustrates an example interface 900 for choosing between benefits profile templates in accordance with example embodiments of the present invention. Although the examples described herein frequently relate to generation of a benefits profile from a set of user-specific questions, it should be appreciated that in some embodiments, users may select from pre-generated profiles to use as templates or examples to assist with generation of a benefits profile or evaluation of a set of plan offerings. The interface 900 shows one possible embodiment for selecting a benefits narrative that allows a user to choose a narrative that is in accordance with their needs. The user may be assigned a particular benefits profile that matches the selected narrative.

The interface 900 illustrates a benefits narrative 902 entitled “Family with kids”, which describes a family that has children and that requires good vision and orthodontic coverage along with some preexisting conditions. A set of benefit goals 904 may be associated with the benefits narrative, breaking down the important features of the benefit narrative that will be used as starting assumptions for making the benefits selections. Interface arrows 906 and 908 may allow the user to select alternative benefits narratives, with the benefits narrative 902 and the benefits goals 904 updating as the user selects different narratives. For example, other narratives might relate to “Single and no kids”, or “Married with working spouse”, or the like, with benefit goals that are in accordance with each narrative. As different narratives are selected using the interface arrows 906, 908, a different benefits profile associated with the selected narrative may be used to derive benefits selections. The user may be presented with the option to customize portions of the benefits narrative, the benefits profile, or the benefits selections associated with each narrative selection. For example, in some embodiments the user may select a phrase or sentence from the benefits narrative and be taken to a questionnaire to alter that portion of the benefits narrative. Altering of the benefits narrative in this manner may also alter the benefits profile corresponding to the narrative and the attendant benefits selections derived from that benefits profile.

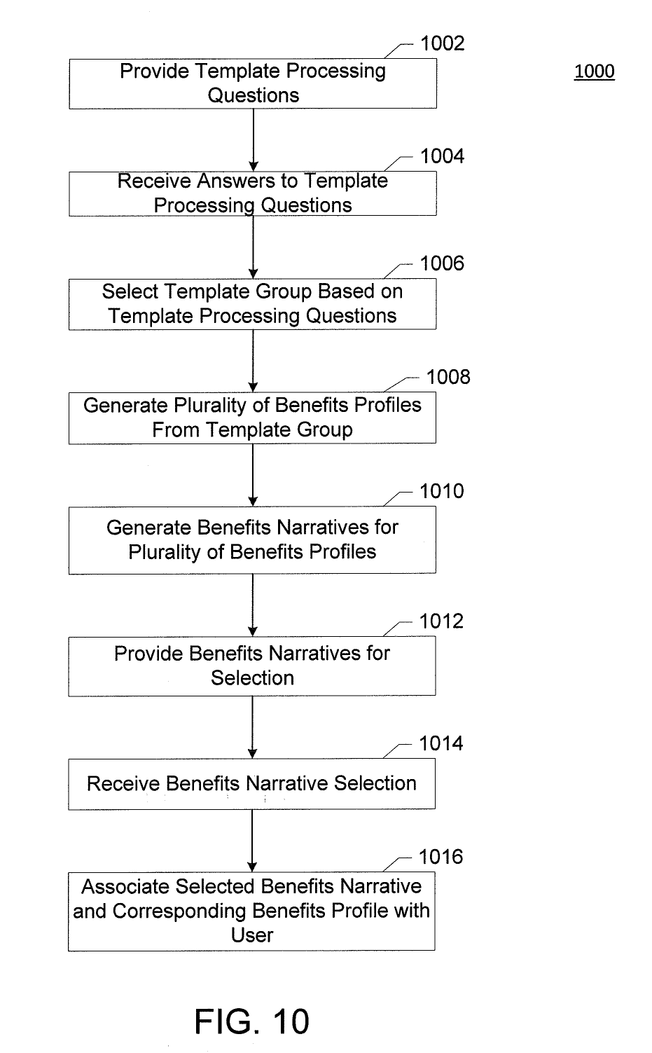

FIG. 10 illustrates an example of a method 1000 for utilizing benefits templates in accordance with some embodiments of the present invention. The method 1000 may allow a user to provide some basic information and then present the user with a series of benefits narratives derived from the information to assist with generating the user's benefits profile.

At action 1002, a set of basic template processing questions may be provided. For example, the template processing questions may include an initial set of data filled out by a user during generation of a benefits profile for the user. These questions may ask the user to provide information such as whether they are married, how many children they have, and their ages.

At action 1004, the user may provide the answers to the template processing questions. At action 1006, one or more template groups may be identified based on the template processing questions. For example, templates, such as the templates described with respect to FIG. 9, may be grouped into categories such as template groups for married users, single users, single users with children, married users with children, users close to retirement age, and the like.

At action 1008, a benefits profile may be generated based on the answers provided to the template processing questions and a set of assumptions associated with each profile in the profile group or groups for which the user qualifies. For example, different profiles may have different assumptions for the importance of retirement to the user, the user's overall health or medical history, the length of time the user can operate financially without a paycheck, and the like. The templates may thus contain default answers that “fill in the blanks” of the user benefits profile left unanswered after the user responds to the template processing questions.

At action 1010, a benefits narrative is generated for each template within the group or groups for which the user qualifies based on the benefits profiles generated at action 1008. These benefits narratives may therefore correspond to the user's personal situation as outlined in the template processing questions, combined with the assumptions and default values provided by each template.

At action 1012, the benefits narratives generated at action 1010 are provided for selection, such as by an interface as described above with respect to FIG. 9. A selection may be received via such an interface at action 1014, representing the user's selection of the benefits narrative that most closely describes the user's situation. At action 1016, the benefits narrative and corresponding benefits profile may be assigned to the user as the user's benefits profile. In this manner, the method provides the user with a straightforward, efficient way for selecting a benefits profile based on a brief narrative description, reducing the need for an extensive questionnaire. In some embodiments, the user may also be presented with the option to modify the base default values and assumptions associated with the template. Modification of the base default values may also result in modification to the benefits narrative as elements of the benefits profile are modified. In this manner, the selected template may serve as a starting point for the generation of the user's benefits profile.

In some embodiments, selection of a particular benefits template may be used to replace a set of one or more questions that would otherwise be used to generate a user benefits profile. For example, a given benefits profile may require a user to answer 50 questions to complete the benefits profile. By selecting a benefits template, a user may reduce the number of questions used to generate the benefits profile. For example, a user may answer an initial group of questions to identify a group of benefits templates, and then select a benefits template from the identified group. Selection of the benefits template may substitute for a number of the questions. Once the benefits template is selected, the user may answer a reduced number of questions to complete the profile. For example, a given benefits profile may require 50 questions to complete the profile. The user may answer 5 initial questions and be presented with a group of benefits templates based on the 5 initial questions. After selecting a benefits template, the benefits template may be used as a substitute for 30 of the 50 questions, requiring the user to only answer another 15 questions to complete the benefits profile.

### Example Benefits Selection Interfaces

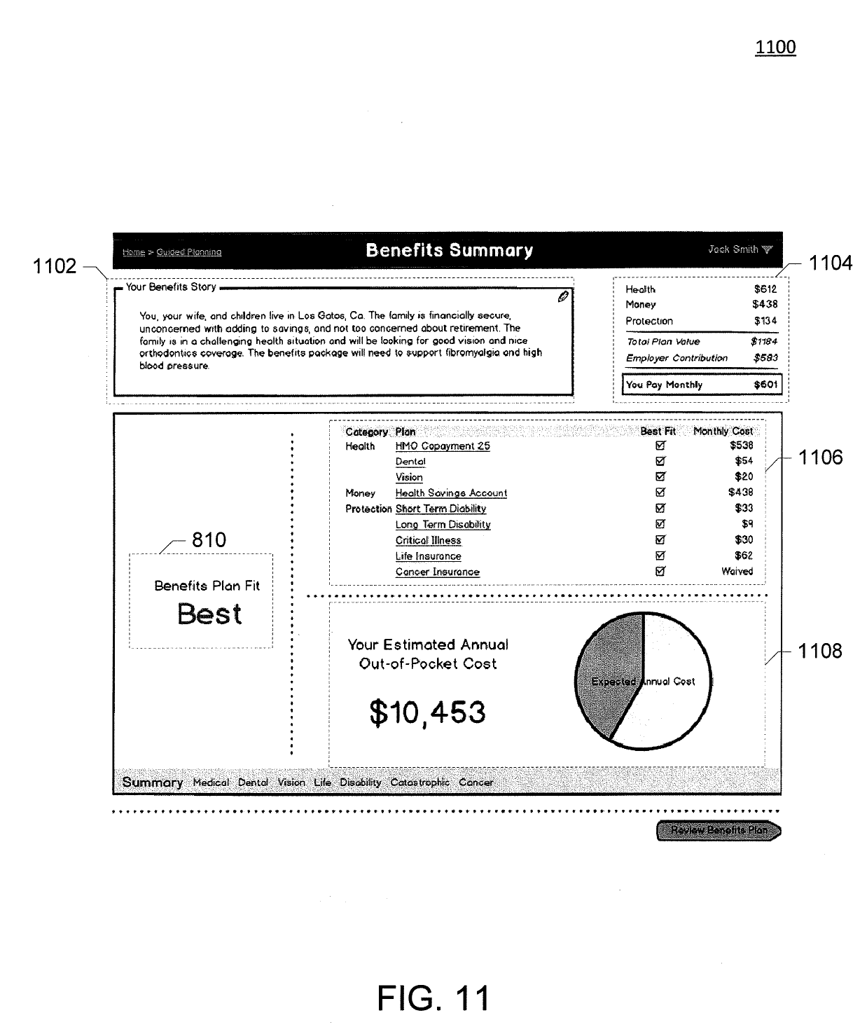

FIGS. 11-15 illustrate example interfaces for selecting benefits in accordance with example embodiments of the present invention. FIG. 11 illustrates an example interface 1100 for displaying a user benefits narrative 1102 in conjunction with a set of benefits selections 1106. The interface 1100 further includes various metrics that allow the user to evaluate their benefits selections. The benefits narrative 1102 provides a natural language description of the user's personal situation as it relates to their benefits selections. A spending overview section 1104 describes a breakdown of the user's monthly costs and the employer's contribution to the user's benefits. The benefits selection interface 1106 allows the user to select one or more benefits for enrollment, and provides price information for each benefit. The out of pocket cost interface 1110 provides a view of the user's out of pocket expenses for the currently selected benefits. A plan fit interface 1110 also depicts how closely the user's current selections match their benefits profile, in order to ensure the user is selecting benefit plans that are in alignment with their benefits profile.

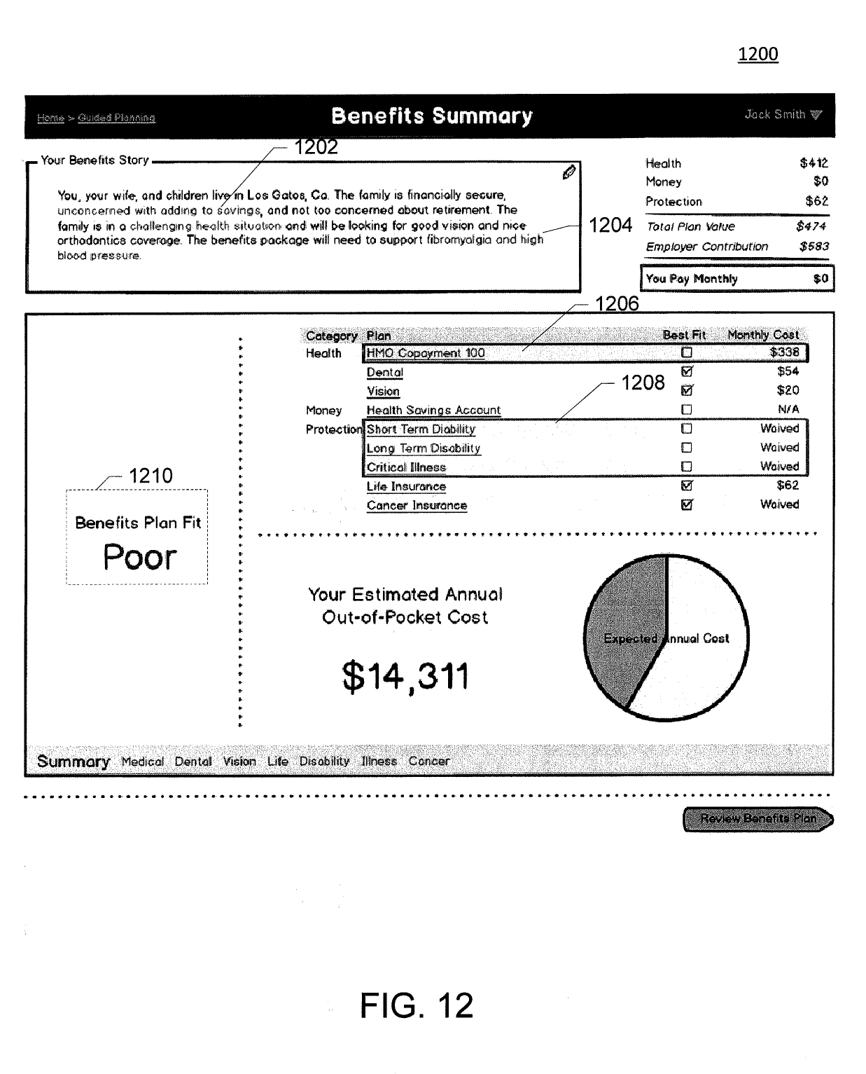

FIG. 12 illustrates an example interface 1200 for using a benefits narrative to inform benefits selections in accordance with example embodiments of the present invention. The interface 1200 shows a benefits narrative that has two highlighted portions 1202, 1204, indicating areas where the selected benefits do not align with the benefits narrative. In the present example, the first highlighted portion 1202 of the user's benefits profile indicates that they are financially secure and unconcerned with adding to savings, and that the family has a challenging health situation. However, the user has elected to waive disability and critical illness coverage, as indicated by a highlighted protection portion 1208 of the benefits selections. Since the user is not concerned with adding to savings and they have a challenging health situation, it stands to reason that they would be willing to pay the extra money for disability and critical illness coverage. As such, the highlighted portion 1208 is in contrast to the first highlighted portion 1202 of the benefits narrative. The second highlighted portion 1204 indicates that the family needs coverage for fibromyalgia and high blood pressure, but the highlighted health portion 1106 of the benefits selections indicates they have chosen a plan that does not have support for either condition. As such, the benefits narrative has been highlighted to indicate that the narrative is out of synch with the benefits selections. Furthermore, the plan fit interface 1210 indicates that the current benefits plan selections are a poor fit for the user's benefits profile. In some embodiments, the user will be presented with the benefits narrative after answering questions in a questionnaire, but before making benefits selections. This may provide users with the ability to confirm their answers to the benefits profile questionnaire in a straightforward, efficient manner.

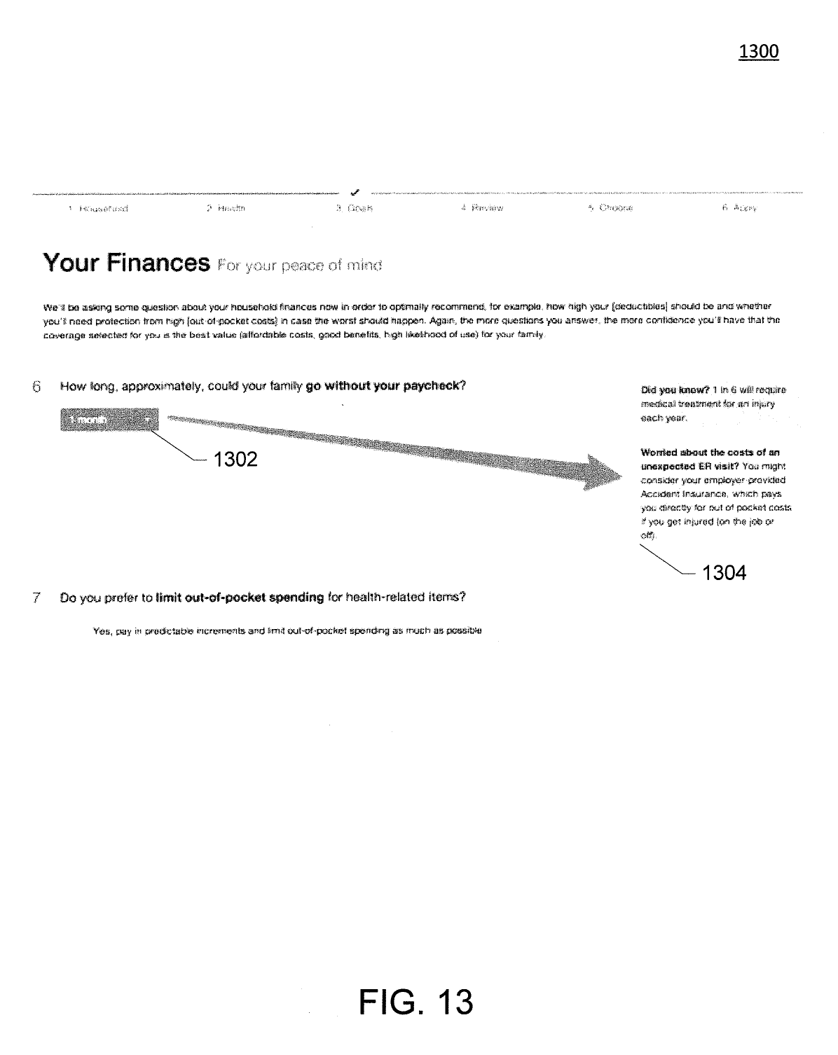

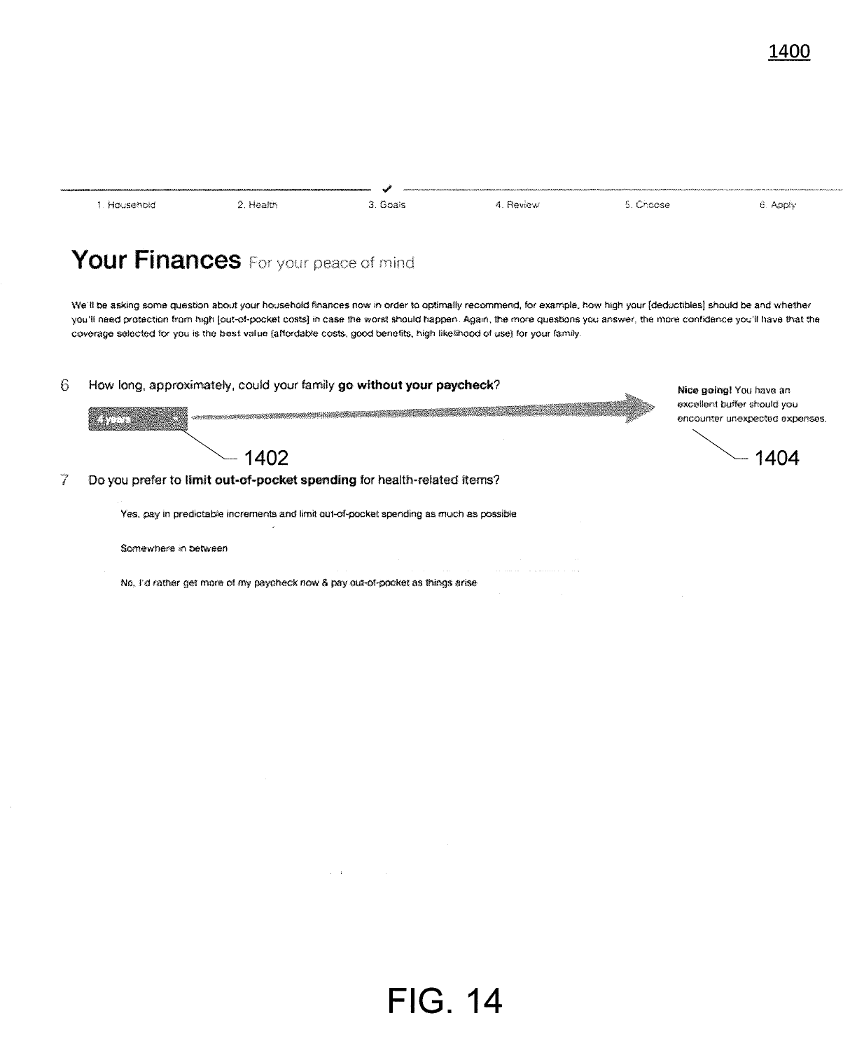

FIGS. 13 and 14 illustrate a dynamic use of a benefits narrative as a user provides answers to a benefit questionnaire. FIGS. 13 and 14 each illustrate different dynamic text provided to a user based on the user's response to a particular question on a benefits questionnaire. In the present example, the user uses drop down control 1302 or 1402 to select how long the user can survive financially without the user's paycheck. In the first example 1300, if the user selects a time period of “1 month” from the drop down control 1302, a text box 1304 may be displayed indicating that the user may wish to consider accident insurance. In this manner, inferences related to the user's benefits profile may be provided dynamically as the questionnaire is completed and the benefits profile is created. In FIG. 14, the user has indicated that they could go for up to 4 years without a paycheck, via the drop down control 1402. As such, the displayed text box 1404 may be altered to indicate the user has a strong financial buffer, such that accident insurance is not as necessary.

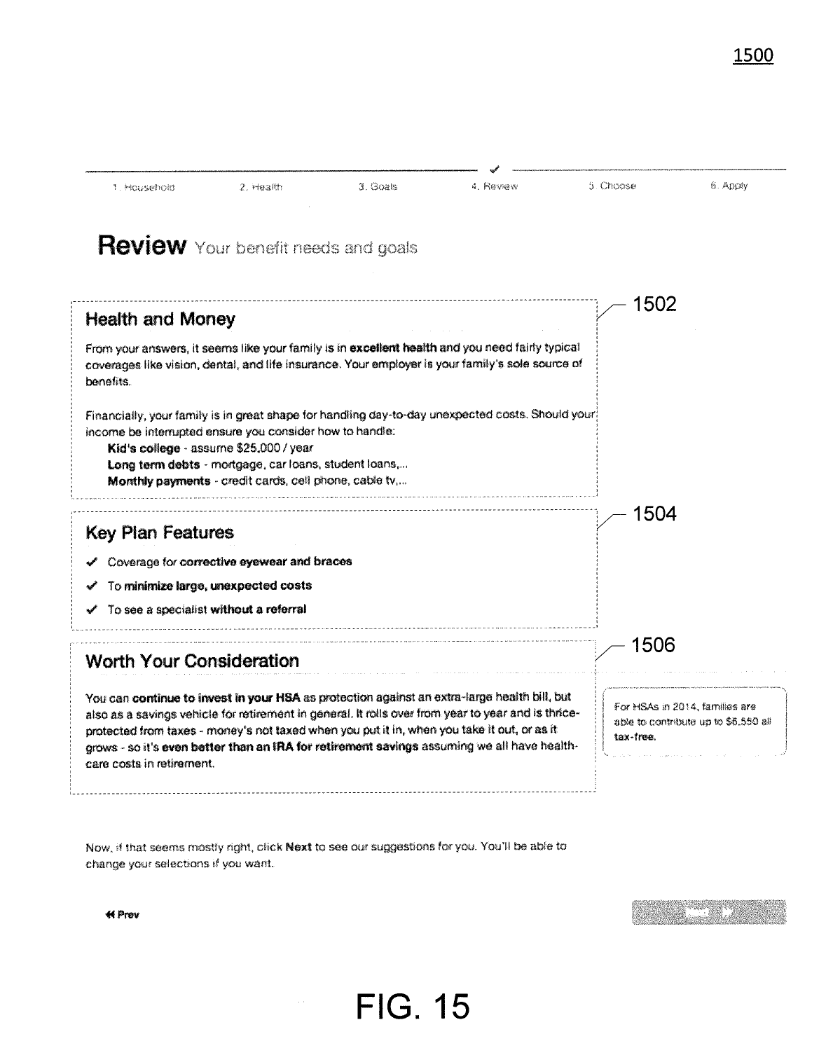

FIG. 15 illustrates an interface 1500 for providing for a review of the user's benefits profile in a narrative format. The interface 1500 may provide the user with the opportunity to review a summary of the user's benefits profile and certain inferences as derived from the benefits profile, prior to making one or more benefits selections. The interface 1500 may also allow the user to confirm their selections from a benefits questionnaire. The interface 1500 may include a profile summary 1502, a list of key features 1504, and a selection strategy 1506. Each of the profile summary 1502, the list of key features 1504, and the selection strategy 1506 may be presented in a natural language format. For example, the profile summary 1502 may provide a summary of the user's personal health and money situation. The list of key features 1504 may present a summary of the plan features identified as most important based on the user's benefits profile. The selection strategy 1506 may present a set of considerations for the user as identified based on the benefits profile.

As will be appreciated, computer program code and/or other instructions may be loaded onto a computer, processor or other programmable apparatus's circuitry to produce a machine, such that execution of the code on the machine by the computer, processor, or other circuitry creates the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or a combination of software and hardware. Furthermore, embodiments may take the form of a computer program product on at least one computer-readable storage medium having computer-readable program instructions (e.g., computer software) embodied in the storage medium. Any suitable computer-readable storage medium may be utilized, including non-transitory hard disks, CD-ROMs, flash memory, optical storage devices, magnetic storage devices, or the like.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus, thereby producing a computer-implemented process such that the instructions executed on the computer or other programmable apparatus cause performance of the steps and thereby implement the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for generating a benefits narrative, the method comprising:
receiving a user benefits profile, the user benefits profile comprising one or more properties indicating the appropriateness of at least one feature of at least one benefit plan for a user;
generating, using a processor, a benefits narrative from the user benefits profile, the benefits narrative comprising a natural language summary of the one or more properties as they define the user's circumstances in relation to the selection of one or more benefits plans; and
displaying the benefits narrative; and
displaying a benefits selection interface.

2. The method of claim 1, wherein the benefits narrative is displayed concurrently with the benefits selection interface.

3. The method of claim 1, wherein the benefits narrative is displayed after generating the benefits profile but prior to displaying the benefits selection interface, and wherein the method further comprises presenting the benefits narrative to confirm information contained within the benefits profile.

4. The method of claim 1, further comprising:
comparing a set of benefits selections displayed in the benefits selection interface with the user benefits profile;
identifying at least one discrepancy between a first portion of the set of benefits selections and at least a first property of the user benefits profile;
determining a first portion of the benefits narrative associated with the first property; and
applying a visual effect to the first portion of the benefits narrative associated with the second property.

5. The method of claim 4, further comprising applying the same visual effect to the first portion of the benefits selections associated with the discrepancy.

6. The method of claim 4, wherein the visual effect comprises a dialogue box displayed in response to a mouse cursor being placed over the first portion of the benefits narrative.

7. The method of claim 1, further comprising:
receiving a response to at least one question from a questionnaire comprising a plurality of questions used to generate the benefits profile, and wherein the benefits narrative is incrementally displayed in response to receiving responses to the questionnaire.

8. The method of claim 4, further comprising:
determining a second discrepancy between a second portion of the set of benefits selections and a second property of the user benefits profile;
determining a second portion of the benefits narrative associated with the second property; and
applying a second visual effect to the second portion of the benefits narrative associated with the second property and a second portion of the benefits selections associated with the second discrepancy.

9. The method of claim 1, further comprising:
receiving a user input selecting at least a portion of the benefits narrative; and
in response to the user input, providing an interface for altering a portion of the user benefits profile associated with the selected portion of the benefits narrative.

10. An apparatus comprising at least one processor coupled to a memory, the memory comprising instructions that, when executed by the processor, cause the apparatus to:
receive a user benefits profile, the user benefits profile comprising one or more properties indicating the appropriateness of at least one feature of at least one benefit plan for a user;
generate a benefits narrative from the user benefits profile, the benefits narrative comprising a natural language summary of the one or more properties as they define the user's circumstances in relation to the selection of one or more benefits plans; and
display the benefits narrative; and
display a benefits selection interface.

11. The apparatus of claim 10, wherein the benefits narrative is displayed concurrently with the benefits selection interface.

12. The apparatus of claim 10, wherein the benefits narrative is displayed after generating the benefits profile but prior to displaying the benefits selection interface, and wherein the apparatus is further caused to present the benefits narrative to confirm information contained within the benefits profile.

13. The apparatus of claim 10, further caused to:
compare a set of benefits selections displayed in the benefits selection interface with the user benefits profile;
identify at least one discrepancy between a first portion of the set of benefits selections and at least a first property of the user benefits profile;
determine a first portion of the benefits narrative associated with the first property; and
apply a visual effect to the first portion of the benefits narrative associated with the second property.

14. The apparatus of claim 13, further caused to apply the same visual effect to the first portion of the benefits selections associated with the discrepancy.

15. The apparatus of claim 13, wherein the visual effect comprises a dialogue box displayed in response to a mouse cursor being placed over the first portion of the benefits narrative.

16. The apparatus of claim 13, further caused to receive a response to at least one question from a questionnaire comprising a plurality of questions used to generate the benefits profile, and wherein the benefits narrative is incrementally displayed in response to receiving responses to the questionnaire.

17. The apparatus of claim 13, further caused to:
determine a second discrepancy between a second portion of the set of benefits selections and a second property of the user benefits profile;
determine a second portion of the benefits narrative associated with the second property; and
apply a second visual effect to the second portion of the benefits narrative associated with the second property and a second portion of the benefits selections associated with the second discrepancy.

18. The apparatus of claim 10, further caused to:
receive a user input selecting at least a portion of the benefits narrative; and
in response to the user input, provide an interface for altering a portion of the user benefits profile associated with the selected portion of the benefits narrative.

19. A computer program product comprising a non-transitory computer readable storage medium, the non-transitory computer readable storage medium comprising instructions that, when executed by a processor, cause the processor to cause an apparatus to:
receive a user benefits profile, the user benefits profile comprising one or more properties indicating the appropriateness of at least one feature of at least one benefit plan for a user;
generate a benefits narrative from the user benefits profile, the benefits narrative comprising a natural language summary of the one or more properties as they define the user's circumstances in relation to the selection of one or more benefits plans; and
display the benefits narrative; and
display a benefits selection interface.

20. The computer program product of claim 19, wherein the benefits narrative is displayed concurrently with the benefits selection interface.

21. The computer program product of claim 19, wherein the benefits narrative is displayed after generating the benefits profile but prior to displaying the benefits selection interface, and wherein the apparatus is further caused to present the benefits narrative to confirm information contained within the benefits profile.

22. The computer program product of claim 19, wherein the apparatus is further caused to:
compare a set of benefits selections displayed in the benefits selection interface with the user benefits profile;
identify at least one discrepancy between a first portion of the set of benefits selections and at least a first property of the user benefits profile;
determine a first portion of the benefits narrative associated with the first property; and
apply a visual effect to the first portion of the benefits narrative associated with the second property.

23. The computer program product of claim 22, wherein the apparatus is further caused to apply the same visual effect to the first portion of the benefits selections associated with the discrepancy.

24. The computer program product of claim 22, wherein the visual effect comprises a dialogue box displayed in response to a mouse cursor being placed over the first portion of the benefits narrative.

25. The computer program product of claim 19, wherein the apparatus is further caused to receive a response to at least one question from a questionnaire comprising a plurality of questions used to generate the benefits profile used to generate the benefits profile, and wherein the benefits narrative is incrementally displayed in response to receiving responses to the questionnaire.

26. The computer program product of claim 19, wherein the apparatus is further caused to:
determine a second discrepancy between a second portion of the set of benefits selections and a second property of the user benefits profile;
determine a second portion of the benefits narrative associated with the second property; and
apply a second visual effect to the second portion of the benefits narrative associated with the second property and a second portion of the benefits selections associated with the second discrepancy.

27. The computer program product of claim 19, wherein the apparatus is further caused to:
receive a user input selecting at least a portion of the benefits narrative; and
in response to the user input, provide an interface for altering a portion of the user benefits profile associated with the selected portion of the benefits narrative.

28. A method for generating a benefits profile, the method comprising:
receiving one or more answers to a set of template processing questions, the answers defining one or more user characteristics;
selecting a template group comprising a plurality of benefits profile templates based on the one or more defined user characteristics;
generating, using a processor, a benefits profile for each of the plurality of benefits profile templates, the benefits profile comprising the one or more user characteristics and one or more default characteristics associated with the benefits profile template;
generating a benefits narrative for each of the generated benefits profiles;
presenting the generated benefits narratives for selection;
receiving a selection of at least one of the generated benefits narratives; and
generating a benefits profile based at least in part on the selected generated benefits narrative.

29. The method of claim 28, further comprising:
determining one or more additional questions based at least in part on the selected benefits profile template; and
receiving one or more responses to the one or more additional questions, wherein the benefits profile is generated based at least in part on the one or more responses and the selected generated benefits narrative.

30. An apparatus comprising at least one processor coupled to a memory, the memory comprising instructions that, when executed by the processor, cause the apparatus to:
receive one or more answers to a set of template processing questions, the answers defining one or more user characteristics;
select a template group comprising a plurality of benefits profile templates based on the one or more defined user characteristics;
generate a benefits profile for each of the plurality of benefits profile templates, the benefits profile comprising the one or more user characteristics and one or more default characteristics associated with the benefits profile template;
generate a benefits narrative for each of the generated benefits profiles;
present the generated benefits narratives for selection;
receive a selection of at least one of the generated benefits narratives; and
generate a benefits profile based at least in part on the selected generated benefits narrative.

31. The apparatus of claim 30, further caused to:
determine one or more additional questions based at least in part on the selected benefits profile template; and
receive one or more responses to the one or more additional questions, wherein the benefits profile is generated based at least in part on the one or more responses and the selected generated benefits narrative.

32. A computer program product comprising a non-transitory computer readable storage medium, the non-transitory computer readable storage medium comprising instructions that, when executed by a processor, cause the processor to cause an apparatus to:
receive one or more answers to a set of template processing questions, the answers defining one or more user characteristics;
select a template group comprising a plurality of benefits profile templates based on the one or more defined user characteristics;
generate a benefits profile for each of the plurality of benefits profile templates, the benefits profile comprising the one or more user characteristics and one or more default characteristics associated with the benefits profile template;
generate a benefits narrative for each of the generated benefits profiles;
present the generated benefits narratives for selection;
receive a selection of at least one of the generated benefits narratives; and
generate a benefits profile based at least in part on the selected generated benefits narrative.

33. The computer program product of claim 32, wherein the apparatus is further caused to:
determine one or more additional questions based at least in part on the selected benefits profile template; and
receive one or more responses to the one or more additional questions, wherein the benefits profile is generated based at least in part on the one or more responses and the selected generated benefits narrative.
